(19) United States
(12) Patent Application Publication
(10) Pub. No.: US 2024/0318421 A1
(43) Pub. Date: Sep. 26, 2024

(54) Facade System and Insulation Element for a Facade System

(71) Applicant: Rockwool A/S, Hedehusene (DK)

(72) Inventors: Dorte Bartnik Johannson, Hedehusene (DK); Miroslav Nikolic, Hedehusene (DK)

(73) Assignee: Rockwool A/S, Hedehusene (DK)

(21) Appl. No.: 18/269,561

(22) PCT Filed: Oct. 1, 2021
(86) PCT No.: PCT/EP2021/077135

§ 371 Date: Dec. 13, 2023

(30) Foreign Application Priority Data
Dec. 30, 2020 (WO) PCT/EP2021/088061

(51) Int. Cl. E04B 1/88; E04B 1/74

(52) U.S. Cl. CPC E04B 1/88; E04B 2001/742

(57) ABSTRACT

The invention relates to a façade system for a building, in particular an External Thermal Insulation Composite System (ETICS), comprising a thermal and/or acoustic insulation, consisting of at least one insulation element being a bonded mineral fibre product made of mineral fibres, preferably stone wool fibres, and a cured aqueous binder composition free of phenol and formaldehyde, wherein the insulation element is fixed to an outer surface of the building by mechanical fastening elements and/or an adhesive, covered with a rendering, and whereby the aqueous binder composition prior to curing comprises a component (i) in form of one or more lignosulfonate lignins having a carboxylic acid group content of 0.03 to 2.0 mmol/g, based on the dry weight of the lignosulfonate lignins and a component (ii) in form of one or more cross-linkers, and wherein the insulation element has a bulk density between 70 kg/m³ and 150 kg/m³.

The present invention relates to a façade system for a building, in particular an External Thermal Insulation Composite System (ETICS), comprising a thermal and/or acoustic insulation, consisting of at least one insulation element being a bonded mineral fibre product made of mineral fibres, preferably stone wool fibres, and a cured aqueous binder composition free of phenol and formaldehyde, wherein the insulation element is fixed to an outer surface of the building by mechanical fastening elements and/or an adhesive, covered with a rendering. Furthermore, the present invention relates to an insulation element for such a façade system, made of mineral fibres, preferably stone wool fibres, and a cured aqueous binder composition free of phenol and formaldehyde.

Façade systems of the above-described type for use as external thermal and/or acoustic insulation of walls of buildings are known in the art. Basically two types of systems are known, namely rear-ventilated façade systems and External Thermal Insulation Composite Systems (ETICSs) with rendering, or combinations of both.

There is disclosed for example in EP 1 731 685 A2 a rear-ventilated thermally insulated building façade which comprises a building wall and an insulating layer of a polymer foam material disposed on the building wall. The system provides a supporting structure disposed on the outside of the insulating layer and a façade cladding supported by said supporting structure. Between said façade cladding and the insulating layer a rear ventilation gap is formed.

The requirements of structural works and building products concerning their arrangement, erection, modification and maintenance are defined and regulated by the construction law, whether in Germany or in other countries, particularly in European countries. These requirements generally serve to prevent the public order and security from being compromised. This particularly applies with respect to safety, i.e. durability (structural, mechanical performance), fire prevention and the prevention or restriction of the spread of fire and smoke. These protection principles form the basis of specific requirements of the construction law to the performance of building materials and building components. Accordingly, there are specific performance requirements for example to external wall claddings, including among others also External Thermal Insulation Composite Systems (ETICS) and rear-ventilated façades.

With respect to ETICSs according to the present invention, reference is made to i.a. the Guideline for European Technical Approval of ETICS with rendering ETAG 004, 2008-06, and e.g. European Standard EN 13162:2012+A1:2015 “Thermal insulation products for buildings—Factory made mineral wool (MW) products”, defining respective requirements.

For decades basically two types of insulation products have been used within ETICSs:
Cellular materials, like e.g. expanded polystyrene (EPS);
Fibrous materials, like e.g. mineral wool (MW) and in particular stone wool.

The latter mineral wool products are well-known for their excellent thermal and acoustic properties, as well as their mechanical strength and superior fire resistance. Said products are also referred to as bonded mineral fibre products made of mineral fibres and a binder. Specific requirements for mineral fibre products, respectively mineral wool insulation for use in ETICS, are moreover defined in national German Technical Approval Z-33.40-92, granted 14 Apr. 2011 to an affiliated company of the assignee.

From WO 2010/046074 A1 a façade insulation system is well known, comprising an external thermal insulation composite system (ETICS) and a building wall, wherein the ETICS is affixed to the building wall. The ETICS comprises an insulation sub-system made of at least insulation elements in board like shape containing mineral wool. The insulation elements are fixed to the building wall by use of mechanical fasteners. Furthermore, the known ETICS is provide with an outer layer, e.g. a rendering system comprising mortar or plates. The insulation elements can additionally be fixed by an adhesive, such as mortar or plaster.

An ETICS may conventionally comprise a plurality of insulation elements, which elements are slab or plate shaped with two major surfaces connected with rectangular side surfaces, and which major surfaces are suited for application of plate fasteners, anchors, profiles etc. or a combination of adhesive and mechanical fastening.

To protect the insulation elements of an ETICS and to provide an appealing appearance, the insulation elements are provided with a rendering consisting of one or more layers, e.g. a base coat of plaster and a top or finishing coat. Usually the base coat also contains a reinforcement. The final surface is provided by a top coat, tiles or the like.

Besides insulation elements of expanded polystyrene rigid foam, mineral fibre or mineral wool products, such as rock wool, glass wool or slag wool is used as a material to produce insulation elements for ETICSs. The insulation elements made from mineral fibre products contain a binder to bind the fibres. The strength characteristics for mineral wool insulation elements depend on the density, the binder content and orientation of the mineral fibres. Commercially known insulation elements for ETICSs have a length of 800 mm and a width of 625 mm; other dimensions are known as well.

The mechanical strength, especially the compressive strength of insulation elements made of mineral fibres may be increased through a length and height compression of a mineral fibres mat during production. The tensile or delamination strength perpendicular to the main surfaces, in the following referred to as the delamination strength is however limited because the mineral fibres in the near-surface zones remain largely parallel to the major surfaces for insulation elements produced by this process; this type of insulation element may be referred to as a “laminar plate” having a tensile strength in the range of about 5 to 35 kPa, such as 5 to 20 kPa cf. the EN 1607:2013.

Another way of changing the mechanical properties of mineral fibre insulation elements is to cut several stripes of mineral wool along the direction of the production line to form lamellas of mineral wool. The lamellas are further cut crosswise to the production line and the loose lamellas thus obtained are each turned 90 degrees. The loose lamellas might be used as individual boards of comparably small size or re-assembled by gluing the lamellas together to form a board with a fibre orientation predominantly perpendicular to the major surface of the board, a so-called lamella board. These boards have a high compression strength perpendicular to the major surfaces and high delamination strength. They are applied to an outer surface of a building so the fibre orientation is predominantly perpendicular to the plane of the building surface. Depending on the condition of the building and/or its height such type of products might be fastened to buildings by an adhesive only, without additional mechanical fastening elements.

In addition to these two basic types of insulation elements for the use in an ETICS there are so-called “dual density mineral wool boards” which have a surface layer of 10 to 20 mm of a compacted mineral wool layer with a density of higher than 150 kg/m³. The high-density surface layer is usually provided to improve the mechanical properties of insulation elements to be used in an ETICS.

Mechanical fasteners are used to assure an even high degree of safety for the application of ETICS; this is of particular importance when tall buildings are insulated because higher wind loads prevail in the upper part of tall buildings and a higher weight load prevails in the lower part of tall buildings due to the increasing own mass of the ETICS.

The fasteners are conventionally made of polyamide and fibre-reinforced polyamide when higher loads are prevailing.

Insulation elements made of mineral fibres besides the mineral fibres contain a binder and the amount of binder may influence the mechanical characteristics of the insulation elements. Nevertheless, the amount of binder to be used is limited as the insulation elements have to fulfill the requirements of fire resistance and most of the binders used and described in the following are based on organic components and therefore not highly fire resistant. Furthermore, the binders used are expensive and have several drawbacks as described in the following.

Mineral fibre products generally comprise man-made vitreous fibres (MMVF) such as, e.g., glass fibres, ceramic fibres, basalt fibres, slag wool, mineral wool and stone wool, which are bonded together by a cured thermoset polymeric binder material. For use as thermal or acoustical insulation products, bonded mineral fibre mats are generally produced by converting a melt made of suitable raw materials to fibres in conventional manner, for instance by a spinning cup process or by a cascade rotor process. The fibres are blown into a forming chamber and, while airborne and while still hot, are sprayed with a binder solution and randomly deposited as a mat or web onto a travelling conveyor. The fibre mat is then transferred to a curing oven where heated air is blown through the mat to cure the binder and rigidly bond the mineral fibres together.

The binder of choice has been phenol-formaldehyde resin which can be economically produced and can be extended with urea prior to use as a binder. However, the existing and proposed legislation directed to the lowering or elimination of formaldehyde emissions have led to the development of formaldehyde-free binders such as, for instance, the binder compositions based on polycarboxy polymers and polyols or polyamines.

Another group of non-phenol-formaldehyde binders are the addition/-elimination reaction products of aliphatic and/or aromatic anhydrides with alkanolamines. These binder compositions are water soluble and exhibit excellent binding properties in terms of curing speed and curing density.

Since some of the starting materials used in the production of these binders are rather expensive chemicals, there is an ongoing need to provide formaldehyde-free binders which are economically produced.

A further effect in connection with previously known aqueous binder compositions for mineral fibres is that at least the majority of the starting materials used for the productions of these binders stem from fossil fuels. There is an ongoing trend of consumers to prefer products that are fully or at least partly produced from renewable materials and there is therefore a need to provide binders for mineral wool which are, at least partly, produced from renewable materials.

A further effect in connection with previously known aqueous binder compositions for mineral fibres is that they involve components which are corrosive and/or harmful. This requires protective measures for the machinery involved in the production of mineral wool products to prevent corrosion and also requires safety measures for the persons handling this machinery. This leads to increased costs and health issues and there is therefore a need to provide mineral fibre products using binder compositions with a reduced content of corrosive and/or harmful materials.

In the meantime, a number of binders for mineral fibre products have been provided, which are to a large extend based on renewable starting materials. In many cases these binders based to a large extend on renewable resources are also formaldehyde-free.

However, many of these binders are still comparatively expensive because they are based on comparatively expensive basic materials.

Moreover, up to now they don't provide adequate strength properties to the final mineral fibre products over time.

Façade systems for buildings, such as ETICSs are to be constructed for a lifetime of 20 years and more and thus require durable materials. Since the loads on such façades are transferred to the structure not only through mechanical fastening the thermal insulation, the bonded mineral fibre products need to be capable of withstanding most of the loading cases, especially wind suction and pressure loads and all-weather conditions likely to be experienced over time. Consequently, mineral fibre products for insulation of external thermal insulation composite systems require a certain robustness which is a matter of density, and which is why such products density typically ranges from e.g. 70 kg/m³ up to around 150 kg/m³ providing certain strength properties, also over time.

Insulation elements of bound mineral fibre products making use of the above-mentioned phenol-formaldehyde resins or urea extended phenol-formaldehyde resins are known to be superior when it comes to loss of strength over time, i.e. due to ageing, and have thus been used for decades. The use of prior art formaldehyde-free or non-added formaldehyde binders (NAF) has proven to be feasible for light-weight products with bulk densities of less than around 60 kg/m³, products that are installed in e.g. cavities or spaces which will subsequently be covered and where there is no need for the products to take-up any loads or provide any specific mechanical resistance. However, these formaldehyde-free binders are seen critical in case of such insulation elements having to withstand loads and mechanical stress for the fact that they are relatively prone to ageing, thus losing their robustness over time.

It is therefore an object of the invention to provide a façade system with mineral fibre elements being applicable for such a façade and avoiding the use of expensive and/or harmful materials for the binder and/or expensive and/or harmful binders per se.

A further object of the invention is to provide mineral fibre elements being applicable for a façade system, especially an ETICS, without using expensive and/or harmful materials for the binder and/or without using expensive and/or harmful binders per se.

In accordance with the present invention the façade system comprises an insulation element of mineral fibres whereby the aqueous binder composition prior to curing comprises a component (i) in form of one or more lignosulfonate lignins having a carboxylic acid group content of 0.03 to 2.0 mmol/g, based on the dry weight of the lignosulfonate lignins and a component (ii) in form of one or more cross-linkers, and wherein the insulation element has a bulk density between 70 kg/m³ and 150 kg/m³.

Furthermore, in accordance with the present invention the insulation element for the façade system is made of mineral fibres, preferably stone wool fibres and a aqueous binder composition, wherein the aqueous binder composition prior to curing comprises a component (i) in form of one or more lignosulfonate lignins having a carboxylic acid group content of 0.03 to 2.0 mmol/g, based on the dry weight of the lignosulfonate lignins, a component (ii) in form of one or more cross-linkers and wherein the insulation element has a bulk density between 70 kg/m³ and 150 kg/m³.

It has been found that it is possible to obtain an insulation element made of mineral fibres and the binder composition as mentioned before which provides the necessary mechanical stability to be used in a façade and an ETICS for a façade whereby the insulation element does not contain a harmful binder and being free of formaldehyde on the one hand and whereby the binder has a high ageing resistance and only a low loss of strength during the lifetime of the façade system. Furthermore, the amount of binder may be reduced compared to the binders without formaldehyde being used in the prior art, such as e.g. existing NAF binders.

In one embodiment, the insulation element may have any of the preferred features described for the façade system.

Preferably the insulation element has a loss on ignition (LOI) within the range of 2 to 8 wt.-%, preferably between 2 and 5 wt.-%. The binder content is taken as the LOI and determined according to European Standard EN 13820:2003. The binder includes oil and other binder additives.

According to a preferred embodiment the façade system is provided with insulation elements with a compression strength between 5 and 90 kPa measured in accordance with European Standard EN 826:2013.

According to another embodiment the façade system is provided with insulation elements with a delamination strength between 5 and 100 kPa measured in accordance with European Standard EN 1607:2013.

Such insulation elements of bonded mineral fibre products are known for their superior fire resistance and are typically, if not otherwise treated or covered with coatings or facings, classified in Euroclass A1 according to European Standard EN 13501-1:2018.

In one embodiment, the mineral wool product according to the present invention comprises mineral fibres in contact with a binder resulting from the curing of an aqueous binder composition free of phenol and formaldehyde comprising:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers.

In particular, in accordance with a first aspect of the present invention, there is provided a mineral fibre product, comprising mineral fibres in contact with a binder resulting from the curing of an aqueous binder composition free of phenol and formaldehyde comprising:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers,
   with the proviso that the aqueous binder composition does not comprise a cross-linker selected from
epoxy compounds having a molecular weight Mw of 500 or less.

In particular, in accordance with a first aspect of the present invention, there is provided mineral fibre product, comprising mineral fibres in contact with a binder resulting from the curing of an aqueous binder composition free of phenol and formaldehyde comprising:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers,
   with the proviso that the aqueous binder composition does not comprise a cross-linker selected from
carbonyl compounds selected from aldehydes, carbonyl compounds of the formula R—[C(O)R₁]ₓ
in which:
R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups,
R₁ represents a hydrogen atom or a C₁-C₁₀ alkyl radical, and
x varies from 1 to 10.

In particular, in accordance with a first aspect of the present invention, there is provided mineral fibre product, comprising mineral fibres in contact with a binder resulting from the curing of an aqueous binder composition free of phenol and formaldehyde comprising:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers,
with the proviso that the aqueous binder composition does not comprise a cross-linker selected from
polyamines.

In particular, in accordance with a first aspect of the present invention, there is provided mineral fibre product, comprising mineral fibres in contact with a binder resulting from the curing of an aqueous binder composition free of phenol and formaldehyde comprising:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers,
with the proviso that the aqueous binder composition does not comprise a cross-linker selected from
   mono- and oligosaccharides.

In one embodiment, the mineral wool product according to the present invention comprises mineral fibres in contact with a binder resulting from the curing of an aqueous binder composition free of phenol and formaldehyde comprising:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers selected from
   β-hydroxyalkylamide-cross-linkers, such as N-(2-hydroxyisopropyl)amide-cross-linkers, such as N-(2-hydroxyethyl)amide-cross-linkers, such as N-(2-hydroxyethyl)adipamide-cross-linkers, such as N,N,N′,N′-tetrakis(2-hydroxyethyl)adipamide and/or
   the group consisting of multifunctional organic amines such as an alkanolamine, diamines, such as hexamethyldiamine, and/or
   epoxy compounds having a molecular weight of more than 500, such as an epoxidised oil based on fatty acid triglyceride or one or more flexible oligomer or polymer, such as a low Tg acrylic based polymer, such as a low Tg vinyl based polymer, such as low Tg polyether, which contains reactive functional groups such as carbodiimide groups, such as anhydride groups, such as oxazoline groups, such as amino groups, such as epoxy groups, and/or
   one or more cross-linkers in form of multifunctional carbodiimides, such as aliphatic multifunctional carbodiimides, and/or
   Primid XL-552,
with the proviso that the aqueous binder composition does not comprise a cross-linker selected from
epoxy compounds having a molecular weight Mw of 500 or less
carbonyl compounds selected from aldehydes, carbonyl compounds of the formula R—[C(O)R₁]ₓ
in which:
R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups,
R₁ represents a hydrogen atom or a C₁-C₁₀ alkyl radical, and
x varies from 1 to 10,
polyamines.

Optionally, the aqueous binder composition additionally comprises
a component (iii) in form of one or more plasticizers.

In one embodiment, the mineral wool product according to the present invention comprises mineral fibres in contact with a binder resulting from the curing of an aqueous binder composition free of phenol and formaldehyde comprising:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers;
a component (iii) in form of one or more plasticizers.

In particular, in accordance with a first aspect of the present invention, there is provided a mineral fibre product, comprising mineral fibres in contact with a binder resulting from the curing of an aqueous binder composition free of phenol and formaldehyde comprising:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers;
a component (iii) in form of one or more plasticizers, with the proviso that the aqueous binder composition does not comprise a cross-linker selected from
   epoxy compounds having a molecular weight Mw of 500 or less.

In particular, in accordance with a first aspect of the present invention, there is provided mineral fibre product, comprising mineral fibres in contact with a binder resulting from the curing of an aqueous binder composition free of phenol and formaldehyde comprising:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers;
a component (iii) in form of one or more plasticizers,
with the proviso that the aqueous binder composition does not comprise a cross-linker selected from
   carbonyl compounds selected from aldehydes, carbonyl compounds of the formula R—[C(O)R₁]ₓ
   in which:
   R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups,
   R₁ represents a hydrogen atom or a C₁-C₁₀ alkyl radical, and
   x varies from 1 to 10.

In particular, in accordance with a first aspect of the present invention, there is provided mineral fibre product, comprising mineral fibres in contact with a binder resulting from the curing of an aqueous binder composition free of phenol and formaldehyde comprising:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers;
a component (iii) in form of one or more plasticizers, with the proviso that the aqueous binder composition does not comprise a cross-linker selected from
   polyamines.

In particular, in accordance with a first aspect of the present invention, there is provided mineral fibre product, comprising mineral fibres in contact with a binder resulting from the curing of an aqueous binder composition free of phenol and formaldehyde comprising:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers;
a component (iii) in form of one or more plasticizers, with the proviso that the aqueous binder composition does not comprise a cross-linker selected from
   mono- and oligosaccharides.

In one embodiment, the mineral wool product according to the present invention comprises mineral fibres in contact with a binder resulting from the curing of an aqueous binder composition free of phenol and formaldehyde comprising:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins,
a component (ii) in form of one or more cross-linkers selected from
   β-hydroxyalkylamide-cross-linkers, and/or
   epoxy compounds having a molecular weight of more than 500, such as an epoxidised oil based on fatty acid triglyceride or one or more flexible oligomer or polymer, such as a low Tg acrylic based polymer, such as a low Tg vinyl based polymer, such as low Tg polyether, which contains reactive functional groups such as carbodiimide groups, such as anhydride groups, such as oxazoline groups, such as amino groups, such as epoxy groups, and/or
   one or more cross-linkers in form of multifunctional carbodiimides, such as aliphatic multifunctional carbodiimides; and/or
   Primid XL-552;
a component (iii) in form of one or more plasticizers, with the proviso that the aqueous binder composition does not comprise a cross-linker selected from
   epoxy compounds having a molecular weight Mw of 500 or less
   carbonyl compounds selected from aldehydes, carbonyl compounds of the formula R—[C(O)R₁]ₓ
   in which:
   R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups,
   R₁ represents a hydrogen atom or a C₁-C₁₀ alkyl radical, and
   x varies from 1 to 10,
   polyamines.

In a preferred embodiment, the binder used in insulation elements according to the present invention being used in façade systems according to the invention are formaldehyde free.

For the purpose of the present application, the term “formaldehyde free” is defined to characterize a mineral wool product where the emission is below 5 μg/m²/h of formaldehyde from the mineral wool product, preferably below 3 μg/m²/h. Preferably, the test is carried out in accordance with ISO 16000 for testing aldehyde emissions.

In a preferred embodiment, the binders are phenol free.

For the purpose of the present application, the term “phenol free” is defined in such a way that the aqueous binder composition does contain phenol

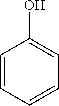

in an amount of ≤0.25 wt.-%, such as ≤0.1 wt.-%, such as ≤0.05 wt.-%, based on the total weight of an aqueous composition having a dry solids binder content of 15 wt. %.

In one embodiment, the binder composition does not contain added formaldehyde.

In one embodiment, the binder composition does not contain added phenol.

For the purpose of the present invention, the term “mono- and oligosaccharides” is defined to comprise monosaccharides and oligosaccharides having 10 or less saccharide units.

For the purpose of the present invention, the term “sugar” is defined to comprise monosaccharides and oligosaccharides having 10 or less saccharide units.

### Component (i)

Component (i) is in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins.

Lignin, cellulose and hemicellulose are the three main organic compounds in a plant cell wall. Lignin can be thought of as the glue, that holds the cellulose fibres together. Lignin contains both hydrophilic and hydrophobic groups. It is the second most abundant natural polymer in the world, second only to cellulose, and is estimated to represent as much as 20-30% of the total carbon contained in the biomass, which is more than 1 billion tons globally.

The lignosulfonate process introduces large amount of sulfonate groups making the lignin soluble in water but also in acidic water solutions. Lignosulfonates has up to 8% sulfur as sulfonate, whereas kraft lignin has 1-2% sulfur, mostly bonded to the lignin. The molecular weight of lignosulfonate is 15.000-50.000 g/mol. The typical hydrophobic core of lignin together with large number of ionized sulfonate groups make this lignin attractive as a surfactant and it often finds application in dispersing cement etc.

To produce lignin-based value-added products, lignin should be first separated from biomass, for which several methods can be employed. Kraft and sulfite pulping processes are known for their effective lignin separation from wood, and hence, are used worldwide. Kraft lignin is separated from wood with the help of NaOH and Na2S. Lignins from sulfite pulping processes are denoted as lignosulfonates, and are produced by using sulfurous acid and/or a sulfite salt containing magnesium, calcium, sodium, or ammonium at varying pH levels. Currently, lignosulfonates account for 90% of the total market of commercial lignin, and the total annual worldwide production of lignosulfonates is approximately 1.8 million tons. Lignosulfonates have generally abundance of sulfonic groups, and thus, a higher amount of sulfur than kraft lignin. Due to the presence of the sulfonated group, lignosulfonates are anionically charged and water soluble. The molecular weights (Mw) of lignosulfonates can be similar to or larger than that of kraft lignin. Due to their unique properties, lignosulfonates have a wide range of uses, such as animal feed, pesticides, surfactants, additives in oil drilling, stabilizers in colloidal suspensions, and as plasticizers in concrete admixtures. However, the majority of new pulp mills employ kraft technology for pulp production, and thus, kraft lignin is more readily available for value-added production.

However, lignosulfonates and kraft lignin have different properties coming from different isolation processes and thus distribution of functional groups. High level of sulfonic groups in lignosulfonates, generally at least one for every four C9 units, makes lignosulfonates strongly charged at all pH levels in water. This abundance of ionisable functional groups can explain most of the differences compared to other technical lignins. Higher charge density allows easier water solubility and higher solid content in solution possible compared to kraft lignin. Also, for the same reason, lignosulfonates will have lower solution viscosity compared to kraft lignin at the same solid content which can facilitate handling and processing. Commonly used model structure of lignosulfonates is shown on FIG. 11.

In one embodiment, component (i) is having a carboxylic acid group content of 0.05 to 0.6 mmol/g, such as 0.1 to 0.4 mmol/g, based on the dry weight of lignosulfonate lignins.

In one embodiment, component (i) is in form of one or more lignosulfonate lignins having an average carboxylic acid group content of less than 1.8 groups per macromolecule considering the M_n wt. average of component (i), such as less than 1.4 such as less than 1.1 such as less than 0.7 such as less than 0.4.

In one embodiment, component (i) is having a content of phenolic OH groups of 0.3 to 2.5 mmol/g, such as 0.5 to 2.0 mmol/g, such as 0.5 to 1.5 mmol/g, based on the dry weight of lignosulfonate lignins.

In one embodiment, component (i) is having a content of aliphatic OH groups of 1.0 to 8.0 mmol/g, such as 1.5 to 6.0 mmol/g, such as 2.0 to 5.0 mmol/g, based on the dry weight of lignosulfonate lignins.

In one embodiment, component (i) comprises ammoniumlignosulfonates and/or calciumlignosulfonates, and/or magnesiumlignosulfonates, and any combinations thereof.

In one embodiment, component (i) comprises ammoniumlignosulfonates and calciumlignosulfonates, wherein the molar ratio of NH₄⁺ to Ca²⁺ is in the range of 5:1 to 1:5, in particular 3:1 to 1:3.

For the purpose of the present invention, the term lignosulfonates encompasses sulfonated kraft lignins.

In one embodiment, component (i) is a sulfonated kraft lignins.

In one embodiment, the aqueous binder composition contains added sugar in an amount of 0 to 5 wt.-%, such as less than 5 wt.-%, such as 0 to 4.9 wt.-%, such as 0.1 to 4.9 wt.-%, based on the weight of lignosulfonate and sugar.

In one embodiment, the aqueous binder composition comprises component (i), i.e. the lignosulfonate, in an amount of 50 to 98 wt.-%, such as 65 to 98 wt.-%, such as 80 to 98 wt.-%, based on the total weight of components (i) and (ii).

In one embodiment, the aqueous binder composition comprises component (i) in an amount of 50 to 98 wt.-%, such as 65 to 98 wt.-%, such as 80 to 98 wt.-%, based on the dry weight of components (i), (ii), and (iii).

For the purpose of the present invention, content of lignin functional groups is determined by using ³¹P NMR as characterization method.

Sample preparation for ³¹P NMR is performed by using 2-chloro-4,4,5,5-tetramethyl-1,3,2-dioxaphospholane (TMDP) as phosphitylation reagent and cholesterol as internal standard. Integration is according to the work of Granata and Argyropoulos (J. Agric. Food Chem. 43:1538-1544).

### Component (ii)

Component (ii) is in form of one or more cross-linkers.

In one embodiment, the component (ii) comprises in one embodiment one or more cross-linkers selected from β-hydroxyalkylamide-cross-linkers and/or oxazoline-cross-linkers.

β-hydroxyalkylamide-cross-linkers is a curing agent for the acid-functional macromolecules. It provides a hard, durable, corrosion resistant and solvent resistant cross-linked polymer network. It is believed the β-hydroxyalkylamide cross-linkers cure through esterification reaction to form multiple ester linkages. The hydroxy functionality of the β-hydroxyalkylamide-cross-linkers should be an average of at least 2, preferably greater than 2 and more preferably 2-4 in order to obtain optimum curing response.

Oxazoline group containing cross-linkers are polymers containing one of more oxazoline groups in each molecule and generally, oxazoline containing cross-linkers can easily be obtained by polymerizing an oxazoline derivative. The patent U.S. Pat. No. 6,818,699 B2 provides a disclosure for such a process.

In one embodiment, the component (ii) is one or more epoxy compounds having a molecular weight of more than 500, such as an epoxidised oil based on fatty acid triglyceride or one or more flexible oligomer or polymer, such as a low Tg acrylic based polymer, such as a low Tg vinyl based polymer, such as low Tg polyether, which contains reactive functional groups such as carbodiimide groups, such as anhydride groups, such as oxazoline groups, such as amino groups, such as epoxy groups, such as β-hydroxyalkylamide groups.

In one embodiment, component (ii) is one or more cross-linkers selected from the group consisting of fatty amines.

In one embodiment, component (ii) is one or more cross-linkers in form of fatty amides.

In one embodiment, component (ii) is one or more cross-linkers selected from polyester polyols, such as polycaprolactone.

In one embodiment, component (ii) is one or more cross-linkers selected from the group consisting of starch, modified starch, CMC.

In one embodiment, component (ii) is one or more cross-linkers in form of multifunctional carbodiimides, such as aliphatic multifunctional carbodiimides.

In one embodiment, the component (ii) is one or more cross-linkers in form of aziridines, such as CX100, NeoAdd-Pax 521/523.

In one embodiment, component (ii) is one or more cross-linkers selected from melamine based cross-linkers, such as a hexakis(methylmethoxy)melamine (HMMM) based cross-linkers.

Examples of such compounds are Picassian XL 701, 702, 725 (Stahl Polymers), such as ZOLDINE® XL-29SE (Angus Chemical Company), such as CX300 (DSM), such as Carbodilite V-02-L2 (Nisshinbo Chemical Inc.).

In one embodiment, component (ii) is Primid XL552, which has the following structure:

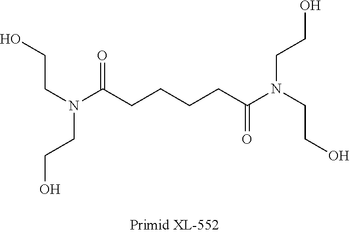 [SMILES: O=C(CCCCC(=O)N(CCO)CCO)N(CCO)CCO]

Component (ii) can also be any mixture of the above mentioned compounds.

In one embodiment, the binder composition according to the present invention comprises component (ii) in an amount of 1 to 50 wt.-%, such as 4 to 20 wt.-%, such as 6 to 12 wt.-%, based on the dry weight of component (i).

In one embodiment, component (ii) is in form of one or more cross-linkers selected from
β-hydroxyalkylamide-cross-linkers, such as N-(2-hydroxyisopropyl)amide-cross-linkers, such as N-(2-hydroxyethyl)amide-cross-linkers, such as N-(2-hydroxyethyl)adipamide-cross-linkers, such as N,N,N′,N′-tetrakis(2-hydroxyethyl)adipamide and/or
the group consisting of multifunctional organic amines such as an alkanolamine, diamines, such as hexamethyldiamine, and/or
epoxy compounds having a molecular weight of more than 500, such as an epoxidised oil based on fatty acid triglyceride or one or more flexible oligomer or polymer, such as a low Tg acrylic based polymer, such as a low Tg vinyl based polymer, such as low Tg polyether, which contains reactive functional groups such as carbodiimide groups, such as anhydride groups, such as oxazoline groups, such as amino groups, such as epoxy groups, and/or
one or more cross-linkers in form of multifunctional carbodiimides, such as aliphatic multifunctional carbodiimides.

In one embodiment, component (ii) comprises one or more cross-linkers selected from
β-hydroxyalkylamide-cross-linkers, such as N-(2-hydroxyisopropyl)amide-cross-linkers, such as N-(2-hydroxyethyl)amide-cross-linkers, such as N-(2-hydroxyethyl)adipamide-cross-linkers, such as N,N,N′,N′-tetrakis(2-hydroxyethyl)adipamide.

In one embodiment, component (ii) comprises component (ii) in an amount of 2 to 90 wt.-%, such as 6 to 60 wt.-%, such as 10 to 40 wt.-%, such as 25 to 40 wt.-%, based on the dry weight of component (i).

Component (iii) of the Binder Composition

Optionally, the binder composition may comprise a component (iii). Component (iii) is in form of one or more plasticizers.

In one embodiment, component (iii) is in form of one or more plasticizers selected from the group consisting of polyols, such as carbohydrates, hydrogenated sugars, such as sorbitol, erythriol, glycerol, monoethylene glycol, polyethylene glycols, polyethylene glycol ethers, polyethers, phthalates and/or acids, such as adipic acid, vanillic acid, lactic acid and/or ferullic acid, acrylic polymers, polyvinyl alcohol, polyurethane dispersions, ethylene carbonate, propylene carbonate, lactones, lactams, lactides, acrylic based polymers with free carboxy groups and/or polyurethane dispersions with free carboxy groups, polyamides, amides such as carbamide/urea, or any mixtures thereof.

In one embodiment, component (iii) is in form of one or more plasticizers selected from the group consisting of carbonates, such as ethylene carbonate, propylene carbonate, lactones, lactams, lactides, compounds with a structure similar to lignin like vanillin, acetosyringone, solvents used as coalescing agents like alcohol ethers, polyvinyl alcohol.

In one embodiment, component (iii) is in form of one or more non-reactive plasticizer selected from the group consisting of polyethylene glycols, polyethylene glycol ethers, polyethers, hydrogenated sugars, phthalates and/or other esters, solvents used as coalescing agents like alcohol ethers, acrylic polymers, polyvinyl alcohol.

In one embodiment, component (iii) is one or more reactive plasticizers selected from the group consisting of carbonates, such as ethylene carbonate, propylene carbonate, lactones, lactams, lactides, di- or tricarboxylic acids, such as adipic acid, or lactic acid, and/or vanillic acid and/or ferulic acid, polyurethane dispersions, acrylic based polymers with free carboxy groups, compounds with a structure similar to lignin like vanillin, acetosyringone.

In one embodiment, component (iii) is in form of one or more plasticizers selected from the group consisting of fatty alcohols, monohydroxy alcohols such as pentanol, stearyl alcohol.

In one embodiment, component (iii) comprises one or more plasticizers selected from the group consisting of polyethylene glycols, polyethylene glycol ethers, and/or one or more plasticizers in form of polyols, such as 1,1,1-Tris(hydroxymethyl)propane, and/or triethanolamine.

Another particular surprising aspect of the present invention is that the use of plasticizers having a boiling point of more than 100° C., in particular 140 to 250° C., strongly improves the mechanical properties of the mineral fibre products according to the present invention although, in view of their boiling point, it is likely that these plasticizers will at least in part evaporate during the curing of the binders in contact with the mineral fibres.

In one embodiment, component (iii) comprises one or more plasticizers having a boiling point of more than 100° C., such as 110 to 380° C., more preferred 120 to 300° C., more preferred 140 to 250° C.

It is believed that the effectiveness of these plasticizers in the binder composition according to the present invention is associated with the effect of increasing the mobility of the lignins during the curing process. It is believed that the increased mobility of the lignins during the curing process facilitates the effective cross-linking.

In one embodiment, component (iii) comprises one or more polyethylene glycols having an average molecular weight of 150 to 50000 g/mol, in particular 150 to 4000 g/mol, more particular 150 to 1000 g/mol, preferably 150 to 500 g/mol, more preferably 200 to 400 g/mol.

In one embodiment, component (iii) comprises one or more polyethylene glycols having an average molecular weight of 4000 to 25000 g/mol, in particular 4000 to 15000 g/mol, more particular 8000 to 12000 g/mol.

In one embodiment component (iii) is capable of forming covalent bonds with component (i) and/or component (ii) during the curing process. Such a component would not evaporate and remain as part of the composition but will be effectively altered to not introduce unwanted side effects e.g. water absorption in the cured product. Non-limiting examples of such a component are caprolactone and acrylic based polymers with free carboxyl groups.

In one embodiment, component (iii) is selected from the group consisting of fatty alcohols, monohydroxy alcohols, such as pentanol, stearyl alcohol.

In one embodiment, component (iii) is selected from one or more plasticizers selected from the group consisting of alkoxylates such as ethoxylates such as butanol ethoxylates, such as butoxytriglycol.

In one embodiment, component (iii) is selected from one or more propylene glycols.

In one embodiment, component (iii) is selected from one or more glycol esters.

In one embodiment, component (iii) is selected from one or more plasticizers selected from the group consisting of adipates, acetates, benzoates, cyclobenzoates, citrates, stearates, sorbates, sebacates, azelates, butyrates, valerates.

In one embodiment, component (iii) is selected from one or more plasticizers selected from the group consisting of phenol derivatives such as alkyl or aryl substituted phenols.

In one embodiment, component (iii) is selected from one or more plasticizers selected from the group consisting of silanols, siloxanes.

In one embodiment, component (iii) is selected from one or more plasticizers selected from the group consisting of sulfates such as alkyl sulfates, sulfonates such as alkyl aryl sulfonates such as alkyl sulfonates, phosphates such as tripolyphosphates; such as tributylphosphates.

In one embodiment, component (iii) is selected from one or more hydroxy acids.

In one embodiment, component (iii) is selected from one or more plasticizers selected from the group consisting of monomeric amides such as acetamides, benzamide, fatty acid amides such as tall oil amides.

In one embodiment, component (iii) is selected from one or more plasticizers selected from the group consisting of quaternary ammonium compounds such as trimethylglycine, distearyldimethylammoniumchloride.

In one embodiment, component (iii) is selected from one or more plasticizers selected from the group consisting of vegetable oils such as castor oil, palm oil, linseed oil, tall oil, soybean oil.

In one embodiment, component (iii) is in form of tall oil.

In one embodiment, component (iii) is selected from one or more plasticizers selected from the group consisting of hydrogenated oils, acetylated oils.

In one embodiment, component (iii) is selected from one or more fatty acid methyl esters.

In one embodiment, component (iii) is selected from one or more plasticizers selected from the group consisting of alkyl polyglucosides, gluconamides, aminoglucoseamides, sucrose esters, sorbitan esters.

In one embodiment, component (iii) is selected from the group consisting of polyethylene glycols, polyethylene glycol ethers.

In one embodiment, component (iii) is selected from the group consisting of triethanolamine.

In one embodiment, component (iii) is in form of propylene glycols, phenol derivatives, silanols, siloxanes, hydroxy acids, vegetable oils, polyethylene glycols, polyethylene glycol ethers, and/or one or more plasticizers in form of polyols, such as 1,1,1-Tris(hydroxymethyl)propane, triethanolamine, or any mixtures thereof.

It has surprisingly been found that the inclusion of plasticizers in the binder compositions according to the present invention strongly improves the mechanical properties of the mineral fibre products according to the present invention.

The term plasticizer refers to a substance that is added to a material in order to make the material softer, more flexible (by decreasing the glass-transition temperature Tg) and easier to process.

Component (iii) can also be any mixture of the above mentioned compounds.

In one embodiment, component (iii) is present in an amount of 0.5 to 60, preferably 2.5 to 25, more preferably 3 to 15 wt.-%, based on the dry weight of component (i).

In one embodiment, component (iii) is present in an amount of 0.5 to 60, preferably 2.5 to 25, more preferably 3 to 15 wt.-%, based on the dry weight of components (i), (ii), and (iii).

Mineral Fibre Product Comprising Mineral Fibres in Contact with a Binder Resulting from the Curing of a Binder Composition Comprising Components (i) and (iia)

In one embodiment the present invention is directed to a mineral fibre product comprising mineral fibres in contact with a binder resulting from the curing of a binder composition for mineral fibres comprising:
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins.
a component (iia) in form of one or more modifiers, preferably with the proviso that the aqueous binder composition does not comprise a cross-linker selected from
   epoxy compounds having a molecular weight Mw of 500 or less, and/or with the proviso that the aqueous binder composition does not comprise a cross-linker selected from
   carbonyl compounds selected from aldehydes, carbonyl compounds of the formula R—[C(O)R₁]ₓ
   in which:
   R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups,
   R₁ represents a hydrogen atom or a C₁-C₁₀ alkyl radical, and
   x varies from 1 to 10,
and/or with the proviso that the aqueous binder composition does not comprise a cross-linker selected from
   polyamines,
and/or with the proviso that the aqueous binder composition does not comprise a cross-linker selected from
   mono- and oligosaccharides.

The present inventors have found that the excellent binder properties can also be achieved by a two-component system which comprises component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins and a component (iia) in form of one or more modifiers, and optionally any of the other components mentioned above and below.

In one embodiment, component (iia) is a modifier in form of one or more compounds selected from the group consisting of epoxy compounds having a molecular weight of more than 500, such as an epoxidised oil based on fatty acid triglyceride or one or more flexible oligomer or polymer, such as a low Tg acrylic based polymer, such as a low Tg vinyl based polymer, such as low Tg polyether, which contains reactive functional groups such as carbodiimide groups, such as anhydride groups, such as oxazoline groups, such as amino groups, such as epoxy groups such as β-hydroxyalkylamide groups.

In one embodiment, component (iia) is one or more modifiers selected from the group consisting of polyethylene imine, polyvinyl amine, fatty amines.

In one embodiment, the component (iia) is one or more modifiers selected from multifunctional carbodiimides, such as aliphatic multifunctional carbodiimides.

Component (iia) can also be any mixture of the above mentioned compounds.

Without wanting to be bound by any particular theory, the present inventors believe that the excellent binder properties achieved by the binder composition for mineral fibres comprising components (i) and (iia), and optional further components, are at least partly due to the effect that the modifiers used as components (iia) at least partly serve the function of a plasticizer and a cross-linker.

In one embodiment, the binder composition comprises component (iia) in an amount of 1 to 40 wt.-%, such as 4 to 20 wt.-%, such as 6 to 12 wt.-%, based on the dry weight of the component (i).

### Further Components

In some embodiments, the mineral fibre product according to the present invention comprises mineral fibres in contact with a binder composition resulting from the curing of a binder which comprises further components.

In one embodiment, the binder composition comprises a catalyst selected from inorganic acids, such as sulfuric acid, sulfamic acid, nitric acid, boric acid, hypophosphorous acid, and/or phosphoric acid, and/or any salts thereof such as sodium hypophosphite, and/or ammonium salts, such as ammonium salts of sulfuric acid, sulfamic acid, nitric acid, boric acid, hypophosphorous acid, and/or phosphoric acid, and/or sodium polyphosphate (STTP), and/or sodium metaphosphate (STMP), and/or phosphorous oxychloride. The presence of such a catalyst can improve the curing properties of the binder compositions according to the present invention.

In one embodiment, the binder composition comprises a catalyst selected from Lewis acids, which can accept an electron pair from a donor compound forming a Lewis adduct, such as ZnCl₂, Mg (ClO₄)₂, Sn [N(SO₂-n-C₈F₁₇)₂]₄.

In one embodiment, the binder composition comprises a catalyst selected from metal chlorides, such as KCl, MgCl₂, ZnCl₂, FeCl₃ and SnCl₂ or their adducts such as AlCl₃ adducts, such as BF₃ adducts, such as BF₃ ethylamine complex.

In one embodiment, the binder composition comprises a catalyst selected from organometallic compounds, such as titanate-based catalysts and stannum based catalysts.

In one embodiment, the binder composition comprises a catalyst selected from chelating agents, such as transition metals, such as iron ions, chromium ions, manganese ions, copper ions and/or from peroxides such as organic peroxides such as dicumyl peroxide.

In one embodiment, the binder composition according to the present invention comprises a catalyst selected from phosphites such as alkyl phosphites, such as aryl phosphites such as triphenyl phosphite.

In one embodiment, the binder composition according to the present invention comprises a catalyst selected from the group of ternary amines such as tris-2,4,6-dimethylaminomethyl phenol.

In one embodiment, the binder composition further comprises a further component (iv) in form of one or more silanes.

In one embodiment, the binder composition comprises a further component (iv) in form of one or more coupling agents, such as organofunctional silanes.

In one embodiment, component (iv) is selected from group consisting of organofunctional silanes, such as primary or secondary amino functionalized silanes, epoxy functionalized silanes, such as polymeric or oligomeric epoxy functionalized silanes, methacrylate functionalized silanes, alkyl and aryl functionalized silanes, urea funtionalised silanes or vinyl functionalized silanes.

In one embodiment, the binder composition further comprises a component (v) in form of one or more components selected from the group of bases, such as ammonia, such as alkali metal hydroxides, such as KOH, such as earth alkaline metal hydroxides, such as Ca(OH)₂, such as Mg(OH)₂, such as amines or any salts thereof.

In one embodiment, the binder composition further comprises a further component in form of urea, in particular in an amount of 5 to 40 wt.-%, such as 10 to 30 wt.-%, 15 to 25 wt.-%, based on the dry weight of component (i).

In one embodiment, the binder composition further comprises a further component in form of one or more carbohydrates selected from the group consisting of sucrose, reducing sugars, in particular dextrose, polycarbohydrates, and mixtures thereof, preferably dextrins and maltodextrins, more preferably glucose syrups, and more preferably glucose syrups with a dextrose equivalent value of DE=30 to less than 100, such as DE=60 to less than 100, such as DE=60-99, such as DE=85-99, such as DE=95-99.

In one embodiment, the binder composition further comprises a further component in form of one or more carbohydrates selected from the group consisting of sucrose and reducing sugars in an amount of 5 to 50 wt.-%, such as 5 to less than 50 wt.-%, such as 10 to 40 wt.-%, such as 15 to 30 wt.-% based on the dry weight of component (i).

In one embodiment, the mineral fibre product according to the present invention comprises mineral fibres in contact with the binder composition comprising a further component in form of one or more silicone resins.

In one embodiment, the binder composition according to the present invention comprises a further component (vi) in the form of one or more reactive or nonreactive silicones.

In one embodiment, the component (vi) is selected from the group consisting of silicone constituted of a main chain composed of organosiloxane residues, especially diphenylsiloxane residues, alkylsiloxane residues, preferably dimethylsiloxane residues, bearing at least one hydroxyl, carboxyl or anhydride, amine, epoxy or vinyl functional group capable of reacting with at least one of the constituents of the binder composition and is preferably present in an amount of 0.025-15 weight-%, preferably from 0.1-10 weight-%, more preferably 0.3-8 weight-%, based on the binder solids.

In one embodiment, the mineral fibre product according to the present invention comprises mineral fibres in contact with the binder composition comprising a further component in form of one or more mineral oils.

In the context of the present invention, a binder composition having a sugar content of 50 wt.-% or more, based on the total dry weight of the binder components, is considered to be a sugar based binder. In the context of the present invention, a binder composition having a sugar content of less than 50 wt.-%, based on the total dry weight of the binder components, is considered a non-sugar based binder.

In one embodiment, the binder composition further comprises a further component in form of one or more surface active agents that are in the form of non-ionic and/or ionic emulsifiers such as polyoxyethylenes (4) lauryl ether, such as soy lecithin, such as sodium dodecyl sulfate.

The use of lignin-based sulfonated products in binders may result in an increase in the hydrophilicity of some binders and final products, meaning one or more hydrophobic agents are to be added, such as one or more mineral oils, such as one or more silicone oil, such as one or more silicone resin.

In one embodiment, the aqueous binder composition consists essentially of
a component (i) in form of one or more lignins selected from the group of:
   lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins, and/or
a component (ii) in form of one or more cross-linkers;
a component (iii) in form of one or more plasticizers;
a component (iv) in form of one or more coupling agents, such as organofunctional silanes;
optionally a component in form of one or more compounds selected from the group of bases, such as ammonia, such as alkali metal hydroxides, such as KOH, such as earth alkaline metal hydroxides, such as Ca(OH)₂, such as Mg(OH)₂, such as amines or any salts thereof;
optionally a component in form of urea;
optionally a component in form of a more reactive or non-reactive silicones;
optionally a hydrocarbon oil;
optionally one or more surface active agents;
water.

In one embodiment, the aqueous binder composition consists essentially of
a component (i) in form of one or more lignins selected from the group of:
   lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins, and/or
a component (ii) in form of one or more cross-linkers;
a component (iv) in form of one or more coupling agents, such as organofunctional silanes;
optionally a component in form of one or more compounds selected from the group of bases, such as ammonia, such as alkali metal hydroxides, such as KOH, such as earth alkaline metal hydroxides, such as Ca(OH)₂, such as Mg(OH)₂, such as amines or any salts thereof;
optionally a component in form of urea;
optionally a component in form of a more reactive or non-reactive silicones;
optionally a hydrocarbon oil;
optionally one or more surface active agents;
water.

The present inventors have surprisingly found that mineral fibre products comprising mineral fibres in contact with a binder resulting in the curing of an aqueous binder composition as it is described above have at a very high stability, both when freshly produced and after aging conditions.

Further, the present inventors have found that even higher product stability can be obtained by using a curing temperature of >230° C.

In one embodiment, the present invention is therefore directed to a mineral fibre product comprising mineral fibres in contact with a binder resulting from the curing of an aqueous binder composition as it is described above, where the curing temperature of >230° C. is used.

The present inventors have further found that the stability of the mineral fibre product can be further increased by the following measures:
Lower line capacity, meaning longer curing time
Addition of silicone resins
Addition of high amounts of crosslinker
Addition of a combination of two or more different crosslinkers
Addition of small amounts of cationic species such as multivalent metal ions such as calcium and/or organic cationic species such as amines and/or organically modified inorganic compounds such as amine modified montmorillonite clays.

### A Method for Producing a Mineral Fibre Product

The present invention also provides a method for producing a mineral fibre product by binding mineral fibres with the binder composition.

Accordingly, the present invention is also directed to a method for producing a mineral fibre product which comprises the steps of contacting mineral fibres with a binder composition comprising
a component (i) in form of one or more lignosulfonate lignins having a carboxylic acid group content of 0.03 to 2.0 mmol/g, such as 0.03 to 1.4 mmol/g, such as 0.075 to 2.0 mmol/g, such as 0.075 to 1.4 mmol/g, based on the dry weight of the lignosulfonate lignins;
a component (ii) in form of one or more cross-linkers;
optionally a component (iii) in form of one or more plasticizers,
   preferably with the proviso that the aqueous binder composition does not comprise a cross-linker selected from
epoxy compounds having a molecular weight Mw of 500 or less
and/or
with the proviso that the aqueous binder composition does not comprise a cross-linker selected from
   carbonyl compounds selected from aldehydes, carbonyl compounds of the formula R—[C(O)R₁]ₓ
      in which:
      R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups,
      R₁ represents a hydrogen atom or a C₁-C₁₀ alkyl radical, and
      x varies from 1 to 10
and/or
with the proviso that the aqueous binder composition does not comprise a cross-linker selected from
   polyamines
and/or
with the proviso that the aqueous binder composition does not comprise a cross-linker selected from
   mono- and oligosaccharides.

### Curing

The web is cured by a chemical and/or physical reaction of the binder components.

In one embodiment, the curing takes place in a curing device.

In one embodiment, the curing is carried out at temperatures from 100 to 300° C., such as 170 to 270° C., such as 180 to 250° C., such as 190 to 230° C.

In one embodiment, the curing takes place in a conventional curing oven for mineral wool production operating at a temperature of from 150 to 300° C., such as 170 to 270° C., such as 180 to 250° C., such as 190 to 230° C.

In one embodiment, the curing takes place for a time of 30 seconds to 20 minutes, such as 1 to 15 minutes, such as 2 to 10 minutes.

The curing process may commence immediately after application of the binder to the fibres. The curing is defined as a process whereby the binder composition undergoes a physical and/or chemical reaction which in case of a chemical reaction usually increases the molecular weight of the compounds in the binder composition and thereby increases the viscosity of the binder composition, usually until the binder composition reaches a solid state.

### Mineral Fibre Product

The present invention is directed to a mineral fibre product comprising mineral fibres in contact with a cured binder composition resulting from the curing of the aqueous binder composition.

The mineral fibres employed may be any of man-made vitreous fibres (MMVF), glass fibres, ceramic fibres, basalt fibres, slag fibres, rock fibres, stone fibres and others. These fibres may be present as a wool product, e.g. like a stone wool product.

### Fibre/Melt Composition

The man-made vitreous fibres (MMVF) can have any suitable oxide composition. The fibres can be glass fibres, ceramic fibres, basalt fibres, slag fibres or rock or stone fibres. The fibres are preferably of the types generally known as rock, stone or slag fibres, most preferably stone fibres.

Stone fibres commonly comprise the following oxides, in percent by weight:
SiO₂: 30 to 51
Al₂O₃: 12 to 30
CaO: 8 to 30
MgO: 2 to 25
FeO (including Fe₂O₃): 2 to 15
Na₂O+K₂O: not more than 10
CaO+MgO: 10 to 30

In preferred embodiments the MMVF have the following levels of elements, calculated as oxides in wt.-%:
SiO₂: at least 30, 32, 35 or 37; not more than 51, 48, 45 or 43
Al₂O₃: at least 12, 16 or 17; not more than 30, 27 or 25
CaO: at least 8 or 10; not more than 30, 25 or 20
MgO: at least 2 or 5; not more than 25, 20 or 15
FeO (including Fe₂O₃): at least 4 or 5; not more than 15, 12 or 10
FeO+MgO: at least 10, 12 or 15; not more than 30, 25 or 20
Na₂O+K₂O: zero or at least 1; not more than 10
CaO+MgO: at least 10 or 15; not more than 30 or 25
TiO2: zero or at least 1; not more than 6, 4 or 2
TiO₂+FeO: at least 4 or 6; not more than 18 or 12
B₂O₃: zero or at least 1; not more than 5 or 3
P₂O₅: zero or at least 1; not more than 8 or 5
Others: zero or at least 1; not more than 8 or 5

The MMVF made by the method of the invention preferably have the composition in wt.-%:
SiO₂ 35 to 50
Al₂O₃ 12 to 30
TiO₂ up to 2
Fe₂O₃ 3 to 12
CaO 5 to 30
MgO up to 15
Na₂O 0 to 15
K₂O 0 to 15
P₂O₅ up to 3
MnO up to 3
B₂O₃ up to 3

Another preferred composition for the MMVF is as follows in wt.-%:
SiO₂ 39-55% preferably 39-52%
Al₂O₃ 16-27% preferably 16-26%
CaO 6-20% preferably 8-18%
MgO 1-5% preferably 1-4.9%
Na₂O 0-15% preferably 2-12%
K₂O 0-15% preferably 2-12%
R₂O (Na₂O+K₂O) 10-14.7% preferably 10-13.5%
P₂O₅ 0-3% preferably 0-2%
Fe₂O₃ (iron total) 3-15% preferably 3.2-8%
B₂O₃ 0-2% preferably 0-1%
TiO₂ 0-2% preferably 0.4-1%
Others 0-2.0%

Glass fibres commonly comprise the following oxides, in percent by weight:
SiO₂: 50 to 70
Al₂O₃: 10 to 30
CaO: not more than 27
MgO: not more than 12

Glass fibres can also contain the following oxides, in percent by weight:

Na₂O+K₂O: 8 to 18, in particular Na₂O+K₂O greater than CaO+MgO B₂O₃: 3 to 12

Some glass fibre compositions can contain Al₂O₃: less than 2%.

Suitable fibre formation methods and subsequent production steps for manufacturing the mineral fibre product are those conventional in the art. Generally, the binder is sprayed immediately after fibrillation of the mineral melt on to the air-borne mineral fibres. The aqueous binder composition is normally applied in an amount of 0.1 to 18%, preferably 0.2 to 8% by weight, of the bonded mineral fibre product on a dry basis.

The spray-coated mineral fibre web is generally cured in a curing oven by means of a hot air stream. The hot air stream may be introduced into the mineral fibre web from below, or above or from alternating directions in distinctive zones in the length direction of the curing oven.

Typically, the curing oven is operated at a temperature of from about 100° C. to about 300° C., such as 170 to 270° C., such as 180 to 250° C., such as 190 to 230° C. Generally, the curing oven residence time is from 30 seconds to 20 minutes, such as 1 to 15 minutes, such as 2 to 10 minutes, depending on, for instance, the product density.

If desired, the mineral wool web may be subjected to a shaping process before curing. The bonded mineral fibre product emerging from the curing oven may be cut to a desired format e.g., in the form of batts, slabs, sheets, plates, strips.

In accordance with the present invention, it is also possible to produce composite materials by combining the bonded mineral fibre product with suitable composite layers or laminate layers such as, e.g., glass surfacing mats and other woven or non-woven materials.

The mineral fibre products according to the present invention generally have a density within the range of from 70 to 150 kg/m³. The mineral fibre products generally have a loss on ignition (LOI) within the range of 2.0 to 8.0 wt.-%, preferably 2.0 to 5.0 wt.-%.

### Use of a Lignin Component for the Preparation of a Binder Composition

The present invention is also directed to the use of a lignin component in form of one or more lignosulfonate lignins having the features as described above for component (i) for the preparation of a binder composition for mineral wool.

In one embodiment, the binder composition is free of phenol and formaldehyde.

In one embodiment, the present invention is directed to the use of a lignin component in the form of one or more lignosulfonate lignins having the features of component (i) described above for the preparation of a binder composition, preferably free of phenol and formaldehyde, for mineral wool, whereby this binder composition further comprises components (ii) and optionally (iii) as defined above, preferably with the proviso that the aqueous binder composition does not comprise a cross-linker selected from
epoxy compounds having a molecular weight Mw of 500 or less and/or
with the proviso that the aqueous binder composition does not comprise a cross-linker selected from
carbonyl compounds selected from aldehydes, carbonyl compounds of the formula R—[C(O)R₁]ₓ
   in which:
   R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups,
   R₁ represents a hydrogen atom or a C₁-C₁₀ alkyl radical, and
   x varies from 1 to 10
and/or
with the proviso that the aqueous binder composition does not comprise a cross-linker selected from
   polyamines
and/or
   with the proviso that the aqueous binder composition does not comprise a cross-linker selected from
mono- and oligosaccharides.

In one embodiment, the present invention is directed to the use of a lignin component in form of one or more lignosulfonate lignins having the features of component (i) described above for the preparation of a binder composition, preferably free of phenol and formaldehyde, whereby the binder composition further comprises component (iia) as defined above.

### EXAMPLES

In the following examples, several binders which fall under the definition of the present invention were prepared and compared to binders according to the prior art.

The following properties were determined for the binders according to the present invention and the binders according to the prior art, respectively:

### Binder Component Solids Content

The content of each of the components in a given binder solution before curing is based on the anhydrous mass of the components.

Lignosulfonates were supplied by Borregaard, Norway and LignoTech, Florida as liquids with approximately 50% solid content. Primid XL552 was supplied by EMS-CHEMIE AG, Silane (Momentive VS-142 40% activity), was supplied by Momentive and was calculated as 100% for simplicity. Silicone resin BS 1052 was supplied by Wacker Chemie AG. NH₄OH 24.7% was supplied by Univar and used in supplied form. PEG 200, urea, KOH pellets, 1,1,1 tris(hydroxymethyl)propane were supplied by Sigma-Aldrich and were assumed anhydrous for simplicity.

### Binder Solids

The content of binder after curing is termed “binder solids”.

Disc-shaped stone wool samples (diameter: 5 cm; height 1 cm) were cut out of stone wool and heat-treated at 580° C. for at least 30 minutes to remove all organics. The solids of the binder mixture were measured by distributing a sample of the binder mixture (approx. 2 g) onto a heat treated stone wool disc in a tin foil container. The weight of the tin foil container containing the stone wool disc was weighed before and directly after addition of the binder mixture. Two such binder mixture loaded stone wool discs in tin foil containers were produced and they were then heated at 200° C. for 1 hour. After cooling and storing at room temperature for 10 minutes, the samples were weighed and the binder solids was calculated as an average of the two results. A binder with desired binder solids could then be produced by diluting with the required amount of water and 10% aq. silane (Momentive VS-142).

### Mechanical Strength Studies

### Bar Tests

The mechanical strength of the binders was tested in a bar test. For each binder, 16 bars were manufactured from a mixture of the binder and stone wool shots from the stone wool spinning production.

A sample of this binder solution having 15% dry solid matter (16.0 g) was mixed well with shots (80.0 g). The resulting mixture was then filled into four slots in a heat resistant silicone form for making small bars (4×5 slots per form; slot top dimension: length=5.6 cm, width=2.5 cm; slot bottom dimension: length=5.3 cm, width=2.2 cm; slot height=1.1 cm). The mixtures placed in the slots were then pressed with a suitably sized flat metal bar to generate even bar surfaces. 16 bars from each binder were made in this fashion. The resulting bars were then cured typically at 225° C. The curing time was 1 h. After cooling to room temperature, the bars were carefully taken out of the containers. Five of the bars were aged in a water bath at 80° C. for 3 h. This method of curing the prepared bars was used for example in Tables 1.1, 1.2, 1.4, 1.5, 1.6. Results in Table 1.3 are based on a slightly different method which includes a preconditioning step of 2 h at 90° C., followed by curing for 1 h at 225° C. while the remaining of the procedure is the same.

After drying for 3 days, the aged bars as well as five unaged bars were broken in a 3-point bending test (test speed: 10.0 mm/min; rupture level: 50%; nominal strength: 30 N/mm²; support distance: 40 mm; max deflection 20 mm; nominal e-module 10000 N/mm²) on a Bent Tram machine to investigate their mechanical strengths. The bars were placed with the “top face” up (i.e. the face with the dimensions' length=5.6 cm, width=2.5 cm) in the machine.

Binder Example, Reference Binder (Phenol-Formaldehyde Resin Modified with Urea, a PUF-Resol)

This binder is a phenol-formaldehyde resin modified with urea, a PUF-resol.

A phenol-formaldehyde resin is prepared by reacting 37% aq. formaldehyde (606 g) and phenol (189 g) in the presence of 46% aq. potassium hydroxide (25.5 g) at a reaction temperature of 84° C. preceded by a heating rate of approximately 1° C. per minute. The reaction is continued at 84° C. until the acid tolerance of the resin is 4 and most of the phenol is converted. Urea (241 g) is then added and the mixture is cooled.

The acid tolerance (AT) expresses the number of times a given volume of a binder can be diluted with acid without the mixture becoming cloudy (the binder precipitates). Sulfuric acid is used to determine the stop criterion in a binder production and an acid tolerance lower than 4 indicates the end of the binder reaction.

To measure the AT, a titrant is produced from diluting 2.5 ml conc. sulfuric acid (>99%) with 1 L ion exchanged water. 5 mL of the binder to be investigated is then titrated at room temperature with this titrant while keeping the binder in motion by manually shaking it; if preferred, use a magnetic stirrer and a magnetic stick. Titration is continued until a slight cloud appears in the binder, which does not disappear when the binder is shaken.

The acid tolerance (AT) is calculated by dividing the amount of acid used for the titration (mL) with the amount of sample (mL):

$$AT = ( Used titration volume ( mL ) ) / ( Sample volume ( mL ) )$$

Using the urea-modified phenol-formaldehyde resin obtained, a binder is made by addition of 25% aq. ammonia (90 mL) and ammonium sulfate (13.2 g) followed by water (1.30 kg).

The binder solids were then measured as described above and the mixture was diluted with the required amount of water and silane for mechanical measurements (15% binder solids solution, 0.5% silane of binder solids).

### Binder Example, Reference Binder (Binder Based on Alkali Oxidized Lignin)

3267 kg of water is charged in 6000 l reactor followed by 287 kg of ammonia water (24.7%). Then 1531 kg of Lignin UPM BioPiva 100 is slowly added over a period of 30 min to 45 min. The mixture is heated to 40° C. and kept at that temperature for 1 hour. After 1 hour a check is made on insolubilized lignin. This can be made by checking the solution on a glass plate or a Hegman gauge. Insolubilized lignin is seen as small particles in the brown binder. During the dissolution step will the lignin solution change colour from brown to shiny black. After the lignin is completely dissolved, 1 liter of a foam dampening agent (Skumdæmper 11-10 from NCÅ-Verodan) is added. Temperature of the batch is maintained at 40° C. Then addition of 307.5 kg 35% hydrogen peroxide is started. The hydrogen peroxide is dosed at a rate of 200-300 l/h. First half of the hydrogen peroxide is added at a rate of 200 l/h where after the dosage rate is increased to 300 l/h.

During the addition of hydrogen peroxide is the temperature in the reaction mixture controlled by heating or cooling in such a way that a final reaction temperature of 65° C. is reached.

The final product was analysed for the COOH group content, dry solid matter, pH, viscosity and remaining H₂O₂·60 g of this oxidized lignin (18.2% solids) was mixed with 1.4 g Primid XL552 (100% solids) and 2.8 g PEG200 (100% solids). 0.6 g Silane (Momentive VS-142 40% activity, 10% in water) and 17.4 g water were added and mixed to yield 15% solids and then used for test of mechanical properties in bar tests.

### Binder Compositions According to the Present Invention

In the following, the entry numbers of the binder example correspond to the entry numbers used in Table 1-1 to 1-6.

The carboxylic acid group content of all lignosulfonates used for the binders according to the present invention was measured using 31P NMR and was found to be in the range of 0.05 to 0.6 mmol/g, based on the dry weight of the lignosulfonate lignins, for all examples.

### Example 2

To 30.0 g lignosulfonate solution (50% solids), 0.4 g NH₄OH (24.7%) was added and mixed followed by addition of 1.9 g Primid XL552 (100% solids) and mixing. Finally, 0.7 g Silane (Momentive VS-142 40% activity, 10% in water) and 64.3 g water were added and mixed to yield 15% solids and then used for test of mechanical properties in bar tests.

### Example 11

To 30.0 g lignosulfonate solution (50% solids), 0.4 g NH₄OH (24.7%) was added and mixed followed by addition of 2.1 g Primid XL552 (100% solids) and 3.4 g PEG 200 (100% solids) and mixing. Finally, 0.7 g Silane (Momentive VS-142 40% activity, 10% in water) and 61.8 g water were added and mixed to yield 15% solids and then used for test of mechanical properties in bar tests.

### Example 15

To 30.0 g lignosulfonate solution (50% solids), 0.4 g NH₄OH (24.7%) was added and mixed followed by addition of 2.9 g Primid XL552 (100% solids) and 3.4 g PEG 200 (100% solids) and mixing. Finally, 0.8 g Silane (Momentive VS-142 40% activity, 10% in water) and 67 g water were added and mixed to yield 15% solids and then used for test of mechanical properties in bar tests.

### Example 30

To 30.0 g lignosulfonate solution (50% solids), 0.4 g NH₄OH (24.7%) was added and mixed followed by addition of 2.9 g Primid XL552 (100% solids) and 3.4 g 1,1,1 tris(hydroxymethyl)propane (100% solids) and mixing. Finally, 0.8 g Silane (Momentive VS-142 40% activity, 10% in water) and 67 g water were added and mixed to yield 15% solids and then used for test of mechanical properties in bar tests.

### Example 33

To 100.0 g lignosulfonate solution (50% solids), 0.3 g KOH in pellet form was added and mixed followed by addition of 10.8 g Primid XL552 (100% solids) and 11.3 g PEG 200 (100% solids) and mixing. Finally, 2.6 g Silane (Momentive VS-142 40% activity, 10% in water) and 228 g water were added and mixed to yield 15% solids and then used for test of mechanical properties in bar tests.

### Example 41

To 30.0 g lignosulfonate solution (50% solids), 0.4 g NH₄OH (24.7%) was added and mixed followed by addition of 1.9 g Primid XL552 (100% solids) and 1.7 g PEG 200 (100% solids) and 1.7 g urea (100% solids) and mixing. Finally, 0.7 g Silane (Momentive VS-142 40% activity, 10% in water) and 60.5 g water were added and mixed to yield 15% solids and then used for test of mechanical properties in bar tests.

Mechanical properties are presented in Tables 1.1-1.6. For simplicity, quantities of all other components are recalculated based on 100 g of dry lignin.

TABLE 1.1

| | Reference binder | | | | | | | | |
|---|---|---|---|---|---|---|---|---|---|
| | (Phenol- | | | | | | | | |
| | formaldehyde | Reference binder | | | | | | | |
| | resin modified with | (binder based on | | | | | | | |
| Binder composition | urea, a PUF-resol) | alkali oxidized lignin) | 1 | 2 | 8 | 9 | 10 | 11 | 15 |
| ammonium lignosulfonate (g dry lignin) | | | 100 | 100 | 100 | 100 | 100 | 100 | 100 |
| ammonium calcium lignosulfonate (g | | | | | | | | | |
| dry lignin) | | | | | | | | | |
| PEG 200 (g) | | | 0 | 0 | 23 | 40 | 23 | 23 | 23 |
| 1,1,1 tris(hydroxymethyl)propane (g) | | | | | | | | | |
| urea (g) | | | | | | | | | |
| NH4OH (g) | | | 0.8 | 0.8 | 0.8 | 0.8 | 0.8 | 0.8 | 0.8 |
| KOH (g) | | | | | | | | | |
| Primid XL552 (g) | | | 0 | 14 | 0 | 0 | 7 | 14 | 20 |
| Momentive VS 142 (% of binder solids), | | | 0.5 | 0.5 | 0.5 | 0.5 | 0.5 | 0.5 | 0.5 |
| based on 40% activity | | | | | | | | | |
| Binder properties | | | | | | | | | |
| Mechanical strength, unaged (N), bars | 350 | 270 | 60 | 280 | 70 | 150 | 110 | 230 | 320 |
| tests | | | | | | | | | |
| Mechanical strength, aged (N), bar tests | 150 | 130 | 0 | 50 | 20 | 40 | 50 | 140 | 130 |
| Curing temp, ° C. | 200 | 225 | 225 | 225 | 225 | 225 | 225 | 225 | 225 |

As can be seen from Table 1.1 a combination of crosslinker (Primid XL 552) and plasticizer (PEG 200) is required to achieve high mechanical properties (unaged and aged strength in bar test) that are at comparable level to reference binder (11 and 15 versus 2 and 9 versus reference binder).

TABLE 1.2

| Binder composition | 12 | 13 | 15 | 26 | 27 | 28 | 29 | 30 |
|---|---|---|---|---|---|---|---|---|
| ammonium lignosulfonate (g dry lignin) | 100 | 100 | 100 | 100 | 100 | 100 | 100 | 100 |
| ammonium calcium lignosulfonate (g dry lignin) | | | | | | | | |
| PEG 200 (g) | 23 | 23 | 23 | | | | | |
| 1,1,1 tris(hydroxymethyl)propane (g) | | | | 23 | 23 | 40 | 23 | 23 |
| urea (g) | | | | | | | | |
| Primid XL552 (g) | 13 | 13 | 20 | 0 | 0 | 0 | 20 | 20 |
| NH4OH (g) | 0.8 | 0.8 | 0.8 | 0.8 | 0.8 | 0.8 | 0.8 | 0.8 |
| KOH (g) | | | | | | | | |
| Momentive VS 142 (% of binder solids), based on 40% | 0 | 0.5 | 0.5 | 0 | 0.5 | 0.5 | 0 | 0.5 |
| activity | | | | | | | | |
| Binder properties | | | | | | | | |
| Mechanical strength, unaged (N), bars tests | 250 | 250 | 320 | 80 | 90 | 90 | 200 | 210 |
| Mechanical strength, aged (N), bar tests | 30 | 110 | 130 | 10 | 10 | 20 | 60 | 100 |
| Curing temp, ° C. | 225 | 225 | 225 | 225 | 225 | 225 | 225 | 225 |

TABLE 1

| | 34 | 36 | 39 | 40 | 41 |
|---|---|---|---|---|---|
| Binder composition | | | | | |
| ammonium lignosulfonate (g dry | 100 | 100 | 100 | 100 | 100 |
| lignin) | | | | | |
| ammonium calcium | | | | | |
| lignosulfonate (g dry lignin) | | | | | |
| PEG 200 (g) | 23 | 12 | 4.5 | 0 | 12 |
| 1,1,1 tris(hydroxymethyl)propane (g) | | | | | |
| urea (g) | | | | | 12 |
| Primid XL552 (g) | 13 | 13 | 13 | 13 | 13 |
| NH4OH (g) | 0.8 | 0.8 | 0.8 | 0.8 | 0.8 |
| KOH (g) | | | | | |
| Momentive VS 142 (% of binder | 0.5 | 0.5 | 0.5 | 0.5 | 0.5 |
| solids), based on 40% activity | | | | | |
| Binder properties | | | | | |
| Mechanical strength, unaged (N), | 150 | 150 | 140 | 60 | 135 |
| bars tests | | | | | |
| Mechanical strength, aged (N), | 60 | 50 | 40 | 20 | 40 |
| bar tests | | | | | |
| Curing temp, ° C. | 225 | 225 | 225 | 225 | 225 |

Table 1.2 and 1.3 show that different plasticizers can be used (13 and 15 versus 30) or combination of plasticizers (34 versus 41) and that the PEG 200 is a preferred plasticizer.

TABLE 1.4

| Binder composition | 12 | 13 | 14 | 15 | 29 | 30 |
|---|---|---|---|---|---|---|
| ammonium lignosulfonate (g dry lignin) | 100 | 100 | 100 | 100 | 100 | 100 |
| ammonium calcium lignosulfonate (g dry lignin) | | | | | | |
| PEG 200 (g) | 23 | 23 | 23 | 23 | | |
| 1,1,1 tris(hydroxymethyl)propane (g) | | | | | 23 | 23 |
| urea (g) | | | | | | |
| Primid XL552 (g) | 13 | 13 | 20 | 20 | 20 | 20 |
| NH4OH (g) | 0.8 | 0.8 | 0.8 | 0.8 | 0.8 | 0.8 |
| KOH (g) | | | | | | |
| Momentive VS 142 (% of binder solids), based on 40% | 0 | 0.5 | 0 | 0.5 | 0 | 0.5 |
| activity | | | | | | |
| Binder properties | | | | | | |
| Mechanical strength, unaged (N), bars tests | 250 | 250 | 380 | 320 | 200 | 210 |
| Mechanical strength, aged (N), bar tests | 30 | 110 | 40 | 130 | 60 | 100 |
| Curing temp, ° C. | 225 | 225 | 225 | 225 | 225 | 225 |

Table 1.4 shows that addition of silane can help achieve aged strength on the same level as reference binders.

TABLE 1

| | 31 | 32 | 33 |
|---|---|---|---|
| Binder composition | | | |
| ammonium lignosulfonate (g dry lignin) | 100 | 100 | 100 |
| ammonium calcium lignosulfonate (g dry lignin) | | | |
| PEG 200 (g) | 23 | 23 | 23 |
| 1,1,1 tris(hydroxymethyl)propane (g) | | | |
| urea (g) | | | |
| Primid XL552 (g) | 22 | 22 | 22 |
| NH4OH (g) | 0 | 1.0 | 0 |
| KOH (g) | 0 | 0 | 0.6 |
| Momentive VS 142 (% of binder solids), based | 0.5 | 0.5 | 0.5 |
| on 40% activity | | | |
| Binder properties | | | |
| Mechanical strength, unaged (N), bars tests | 330 | 300 | 290 |
| Mechanical strength, aged (N), bar tests | 160 | 120 | 130 |
| Curing temp, ° C. | 225 | 225 | 225 |

Table 1.5 shows that the binder has high strength without the presence of a base but that a non-permanent base (NH₄OH) or a permanent base (KOH) can be added to the formulation to protect the production equipment from corrosion without significant changes in strength.

TABLE 1

| | 11 | 15 | 45 | 46 |
|---|---|---|---|---|
| Binder composition | | | | |
| ammonium lignosulfonate (g dry lignin) | 100 | 100 | | |
| ammonium calcium lignosulfonate (g | | | 100 | 100 |
| dry lignin) | | | | |
| PEG 200 (g) | 23 | 23 | 23 | 23 |
| 1,1,1 tris(hydroxymethyl)propane (g) | | | | |
| urea (g) | | | | |
| Primid XL552 (g) | 13 | 20 | 13 | 20 |
| NH4OH (g) | 0.8 | 0.8 | 0.8 | 0.8 |
| KOH (g) | | | | |
| Momentive VS 142 (% of binder solids), | 0.5 | 0.5 | 0.5 | 0.5 |
| based on 40% activity | | | | |
| Binder properties | | | | |
| Mechanical strength, unaged (N), bar tests | 230 | 320 | 210 | 300 |
| Mechanical strength, aged (N), bar tests | 140 | 130 | 120 | 130 |
| Curing temp, ° C. | 225 | 225 | 225 | 225 |

Table 1.6 shows that different lignosulfonates can be used.

This overall means, we are able to produce a mineral wool product based on a phenol and formaldehyde-free binder composition with a high content of renewable material based on lignin, which has comparable mechanical properties to the reference systems and can be produced in a simpler and less expensive way.

### Examples 47 and 49

In the following, the entry numbers of the binder example correspond to the entry numbers used in Table 2.

The carboxylic acid group content of all lignosulfonates used for the binders according to the present invention was measured using 31P NMR and was found to be in the range of 0.05 to 0.6 mmol/g, based on the dry weight of the lignosulfonate lignins, while it was found for this specific batch used for examples 47, 49 to be 0.14 mmol/g.

### Example 47

To 30.0 g lignosulfonate solution (50% solids), 0.4 g NH₄OH (24.7%) was added and mixed followed by addition of 0.7 g Silane (Momentive VS-142 40% activity, 10% in water) and 68.9 g water were added and mixed to yield 15% solids and then used for test of mechanical properties in bar tests.

### Example 49

To 30.0 g lignosulfonate solution (50% solids), 0.4 g NH₄OH (24.7%) was added and mixed followed by addition of 6.0 g Primid XL552 (100% solids) and mixing. Finally, 1.0 g Silane (Momentive VS-142 40% activity, 10% in water) and 102.6 g water were added and mixed to yield 15% solids and then used for test of mechanical properties in bar tests. Mechanical properties are presented in Table 2. For simplicity, quantities of all other components are recalculated based on 100 g of dry lignin.

TABLE 2

| | PUF | | | | |
|---|---|---|---|---|---|
| Binder composition | ref | 47 | 48 | 49 | 50 |
| ammonium lignosulfonate | | 100 | 100 | 100 | 100 |
| (g solids) | | | | | |
| PEG 200 (g) | | 0 | 0 | 0 | 0 |
| urea (g) | | | | | |
| ammonia, 24.7% (g) | | 2.5 | 2.5 | 2.5 | 2.5 |
| Primid XL552 (g) | | 0 | 25 | 40 | 60 |
| Momentive VS 142 (% of | | 0.5 | 0.5 | 0.5 | 0.5 |
| binder solids), based on | | | | | |
| 40% activity | | | | | |
| Binder properties | | | | | |
| Mechanical strength, | 350 | 60 | 280 | 460 | 640 |
| unaged (N), bars tests | | | | | |
| Mechanical strength, aged | 150 | 0 | 160 | 180 | 230 |
| (N), bar tests | | | | | |
| Curing temp, ° C. | 200 | 225 | 225 | 225 | 225 |

As can be seen from Table 2, in a combination of lignosulfonate and crosslinker (Primid XL 552) higher amounts of crosslinker lead to better mechanical properties.

### Example: Test of Stone Wool Products

Products have been examined for properties according to the product standard for Factory made mineral wool (MW) products, EN13162:2012+A1:2015, meaning relevant mechanical properties besides other basic characteristics for stone wool products.

The testing has been performed on slabs, where test specimens according to the dimensional specifications and to the number of test specimens required to get one test result, as stated in EN13162 for each of the different test methods, has been cut out. Each of the stated values for the mechanical properties obtained is an average of more results according to EN13162.

### Dimensions

Dimensions of products and test specimens has been performed according to the relevant test methods, EN822:2013: Thermal insulating products for building applications—Determination of length and width, and EN823:2013: Thermal insulating products for building applications-Determination of thickness.

### Binder Content (Loss on Ignition)

Determination of binder content is performed according to EN13820:2003: Thermal insulating materials for building applications-Determination of organic content, where the binder content is defined as the quantity of organic material burnt away at a given temperature, stated in the standard to be (500±20° C.). In the testing the temperature (590±20° C., for at least 10 min or more until constant mass) has been used in order to make sure that all organic material is burnt away. Determination of ignition loss consists of at least 10 g wool corresponding to 8-20 cut-outs (minimum 8 cut-outs) performed evenly distributed over the test specimen using a cork borer ensuring to comprise an entire product thickness. The binder content is taken as the LOI. The binder includes oil and other binder additives.

### Example 54

The stone wool product has been produced by use of binder in example 54, at a curing oven temperature set to 255° C.

730.0 kg of ammonium lignosulfonate was placed in a mixing vessel to which 8.5 l NH₄OH (24.7%) was added and stirred. Afterwards, 151 kg Primid XL552 solution (pre-made 31 wt.-% solution in water) and 43 kg PEG 200 (100% solids) were added and mixed followed by addition of 13 kg Silane (Momentive VS-142 40% activity, 10% in water) and 40 kg silicone (Wacker BS 1052, 12% in water).

The binder from this example is used to produce a high density stone wool product, 100 mm thickness, 145 kg/m³ density wherein the insulation element has a loss on ignition (LOI) of 3.5 wt.-%. Curing oven temperature was set to 255° C.

### Example 55

The stone wool product has been produced by use of binder in example 55, at a curing oven temperature set to 255° C.

609.0 kg of ammonium lignosulfonate was placed in a mixing vessel to which 8 l NH₄OH (24.7%) was added and stirred. Afterwards, 384 kg Primid XL552 solution (pre-made 31 wt.-% solution in water) was added and mixed followed by addition of 14 kg Silane (Momentive VS-142 40% activity, 10% in water).

The binder from this example is used to produce a high density stone wool product, 100 mm thickness, 145 kg/m³ density and with a loss on ignition (LOI) of 3.5 wt.-%. Curing oven temperature was set to 255° C.

### Comparative Examples

As a reference comparative examples of mineral fibre products have been prepared. Comparative Example A represents a stone wool product containing a traditional phenol-urea-formaldehyde binder (PUF) whereas Comparative Example B represents a stone wool product produced with one of the assignees prior art non-added formaldehyde binder (NAF).

### Comparative Example A (PUF)

This binder is a phenol-formaldehyde resin modified with urea, a PUF-resol.

A phenol-formaldehyde resin is prepared by reacting 37% aq. formaldehyde (606 kg) and phenol (189 kg) in the presence of 46% aq. potassium hydroxide (25.5 kg) at a reaction temperature of 84° C. preceded by a heating rate of approximately 1° C. per minute. The reaction is continued at 84° C. until the acid tolerance of the resin is 4 and most of the phenol is converted. Urea (241 kg) is then added and the mixture is cooled.

The acid tolerance (AT) expresses the number of times a given volume of a binder can be diluted with acid without the mixture becoming cloudy (the binder precipitates). Sulfuric acid is used to determine the stop criterion in a binder production and an acid tolerance lower than 4 indicates the end of the binder reaction.

To measure the AT, a titrant is produced from diluting 2.5 ml conc. sulfuric acid (>99%) with 1 L ion exchanged water. 5 mL of the binder to be investigated is then titrated at room temperature with this titrant while keeping the binder in motion by manually shaking it; if preferred, use a magnetic stirrer and a magnetic stick. Titration is continued until a slight cloud appears in the binder, which does not disappear when the binder is shaken.

The acid tolerance (AT) is calculated by dividing the amount of acid used for the titration (mL) with the amount of sample (mL):

$$AT = ( Used titration volume ( mL ) ) / ( Sample volume ( mL ) )$$

Using the urea-modified phenol-formaldehyde resin obtained, a binder is made by addition of 25% aq. ammonia (90 L) and ammonium sulfate (13.2 kg) followed by water (1300 kg).

The binder solids were then measured as described above and the mixture was diluted with the required amount of water and silane for mechanical measurements.

A mineral fibre product was prepared with 100 mm mineral wool bonded with this prior art binder composition. The density of the mineral fibre product was 145 kg/m³. The ignition loss was 3.5 wt.-%. The proportion of the cured binder composition in the mineral fibre product was 3.4 wt.-% due to 0.1 wt.-% mineral oil.

### Comparative Example B (NAF)

A mixture of 75.1% aq. glucose syrup (19.98 kg; thus efficiently 15.0 kg glucose syrup), 50% aq. hypophosphorous acid (0.60 kg; thus efficiently 0.30 kg, 4.55 mol hypophosphorous acid) and sulfamic acid (0.45 kg, 4.63 mol) in water (30.0 kg) was stirred at room temperature until a clear solution was obtained. 28% aq. ammonia (0.80 kg; thus efficiently 0.22 kg, 13.15 mol ammonia) was then added dropwise until pH=7.9. The binder solids were then measured (21.2%). In order to obtain a suitable binder composition (15% binder solids solution, 0.5% silane of binder solids), the binder mixture was diluted with water (0.403 kg/kg binder mixture) and 10% aq. silane (0.011 kg/kg binder mixture, Momentive VS-142). The final binder mixture had pH=7.9.

Mineral fibre products were prepared with a thickness of 100 mm, a density of 145 kg/m³ and LOI at 3.5 wt.-%.

A common method for producing the mineral fibre product as described in the description above is used.

The invention is illustrated in the accompanying drawings in which

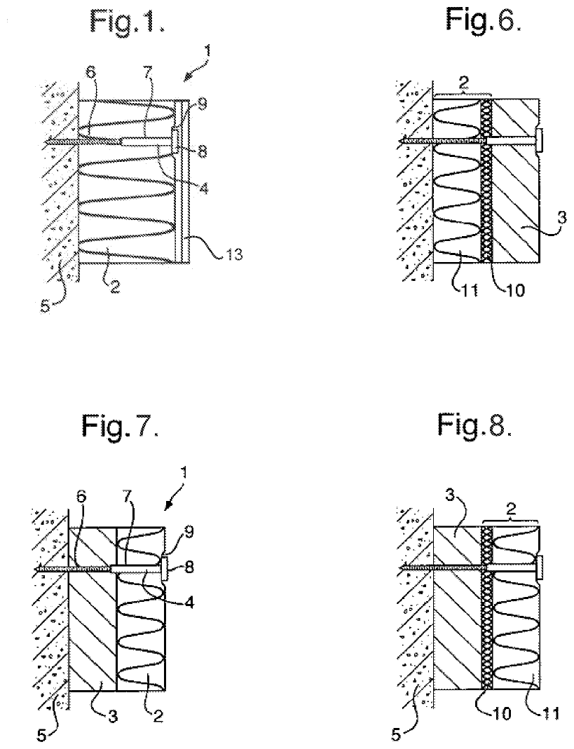

FIG. 1 shows a first embodiment of a façade system according to the invention;

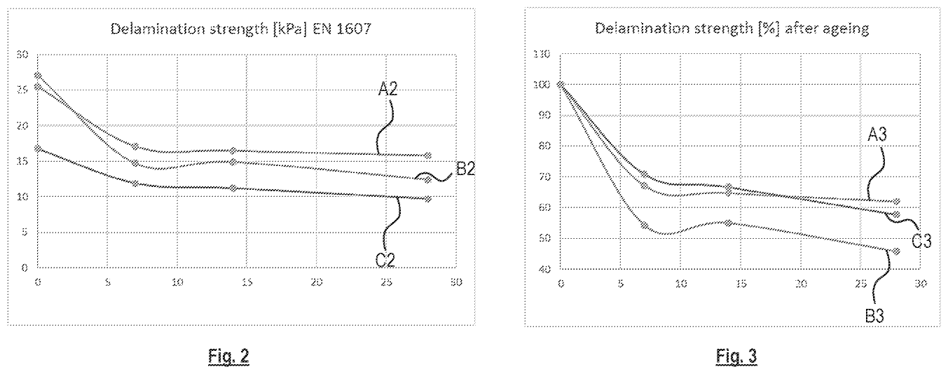

FIG. 2 shows a diagram showing the delamination strength of an insulation element used in an ETICS compared to the delamination strength of an insulation element according to the prior art;

FIG. 3 shows a diagram showing the delamination strength of an insulation element used in an ETICS after ageing compared to the delamination strength of an insulation element according to the prior art after ageing;

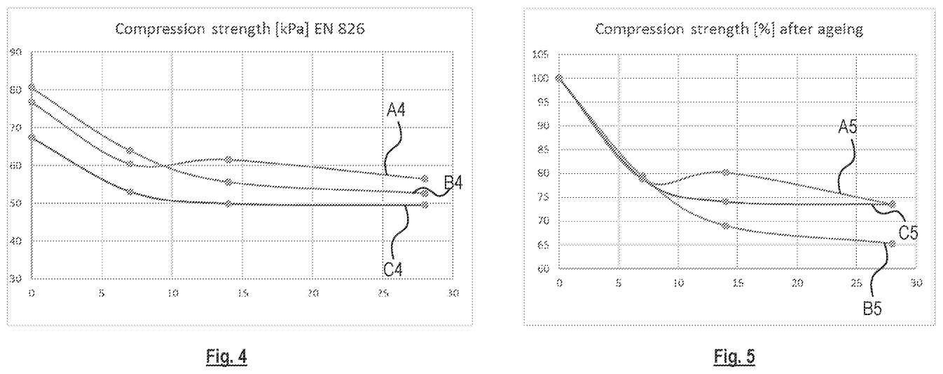

FIG. 4 shows a diagram showing the compression strength of an insulation element used in an ETICS compared to the compression strength of an insulation element according to the prior art;

FIG. 5 shows a diagram showing the compression strength of an insulation element used in an ETICS after ageing compared to the compression strength of an insulation element according to the prior art after ageing

FIG. 6 shows a second embodiment of a mounted insulation element being part of an ETICS according to the present invention;

FIG. 7 shows a third embodiment of a mounted insulation element being part of an ETICS according to the present invention;

FIG. 8 shows a fourth embodiment of a mounted insulation element being part of an ETICS according to the present invention;

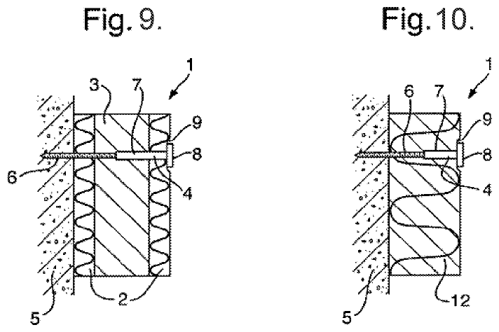

FIG. 9 shows a fifth embodiment of a mounted insulation element being part of an ETICS according to the present invention; and

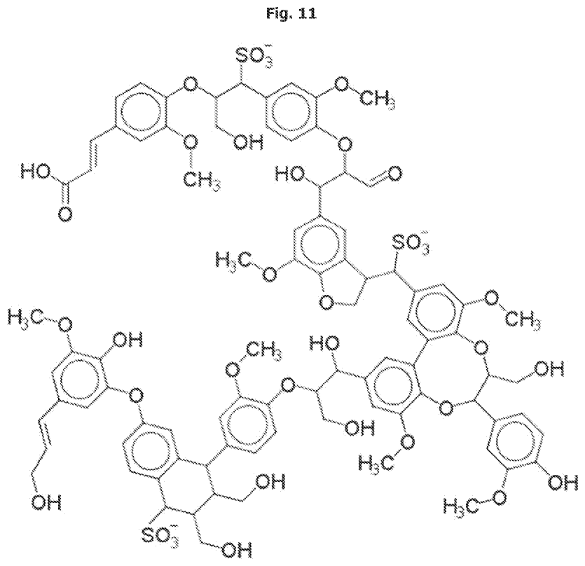

FIG. 10 shows a sixth embodiment of a mounted insulation element being part of an ETICS according to the present invention and

FIG. 11 shows a section from a possible lignin structure.

FIGS. 1 and 6 to 10 show different embodiments of façade systems (ETICS) according to the invention each comprising a thermal and/or acoustic insulation of at least one insulation element, mechanical fasteners 4 and a rendering 13 (not shown in FIGS. 7 to 10). The insulation element comprises at least a bonded mineral fibre or mineral wool product made from mineral fibres and a binder. In the following said insulation element is also referred to as mineral wool insulation plate 2, or insulation plate 2, or insulating composite plate 12 containing mineral wool and aerogel. Other embodiments of the insulation element comprise a plate 3 representing an aerogel particle fibre composite, further below also referred to as aerogel containing plate 3.

A first embodiment of a façade system is shown in FIG. 1 represented by an insulation sub-system 1 as a part of the ETICS comprising a mineral wool insulation plate 2 at a building wall 5 and mounted by a mechanical fastener 4 into the building wall 5 holding the insulation plate 2. The insulation plate 2 is glued (not shown) to the wall 5. The part of the ETICS is shown in cross section displaying the mechanical fastener 4. The mechanical fastener 4 is a polyamide based hollow dowel 7 with a metal screw 6 inserted in the hollow dowel 7. The dowel 7 has a head 8 in shape of a round plate with a diameter of preferably around 90 mm. The head 8 exerts a pressure on the surface of the insulation plate 2 and there is a slight indentation 9 into the surface due to the static hold force of the mounted screw 6. The total system of fastener 4 and insulation plate 2 forming an insulation sub-system which is mechanically rigid and resistant to wind loads.

The insulation shown in FIG. 1 consists of insulation plates 2 made from mineral wool and each having a rectangular major surface onto which a rendering is applied. The rendering 13 is made from two layers of mortar and the layer being in direct contact to the insulation plate is a so-called base coat.

Instead of a one layered insulation plate 2 multilayered insulation plates can be used, each having at least two layers of different density. These insulation plates are so-called dual-density plates and are shown in a second embodiment according to FIG. 6.

The insulation plate 2 may also be a mineral wool lamella plate which consists of several lamellas of mineral wool glued together in their length direction to form the plate and where the mineral fibre direction is predominantly perpendicular to the major surface as is conventional for such mineral wool lamella plates. The thickness is 100 mm and the width by length is 400 by 1200 mm and the density of the mineral wool plate is 75 kg/m³.

A plate 3 (FIG. 6) can be present, representing an aerogel particle fibre composite comprising stone fibres, aerogel particles and a means for binding the constituents and covering the insulation plate 2.

FIG. 6 shows an insulation sub-system like in FIG. 1 with the amendment that the insulation plate 2 shown in FIG. 6 is a dual density mineral wool plate which has a surface layer 10 of about 20 mm thickness of a compacted mineral wool layer with a density of about 160 kg/m³ and a layer 11 of about 120 mm thickness of mineral wool layer with a density of about 90 kg/m³; the layer 11 with the lower density is facing the wall 5 and the layer 10 with the higher density is facing the plate 3. The plate 3 improves the thermal performance of the ETICS and may be connected to insulation plate 2 by using an adhesive which might be the binder used in the insulation plate 2. Furthermore, the binder used in the plate 3 being a matrix of mineral fibres and additives, such as aerogel particles, can be identical with the binder used in the insulation plate 2. The plate 3 increases the insulation properties of the ETICS. Plate 3 can be connected to the insulation plate 2 by an adhesive which can be the binder used in the insulation plate 2.

FIG. 7 shows an insulation sub-system comprising a plate 3 provided on the building wall 5 and arranging a insulation plate 2 on top of the plate 3 and mounting a mechanical fastener 4 into the wall 5 holding both the plates 2, 3; the plate 3 is glued (not shown) to the wall 5 and can be identical to the plate 3 according to FIG. 6. The part of the ETICS is shown in cross section displaying the mechanical fastener 4. The mechanical fastener 4 is a polyamide based hollow dowel 4 with a metal screw 6 inserted in the hollow element 7 and the dowel 4 has a head 8 in shape of a round plate with a diameter of preferably around 60 mm. The head 8 exerts a pressure on the surface of the insulation plate 2 and there is an indentation 9 into the surface due to the static hold force of the mounted screw 6 and the mineral wool of the insulation plate 2 is compressed between the fastener head 8 and the surface of the aerogel containing plate 3. The total system of fasteners, insulation plate 2 and plate 3 is mechanically rigid and has improved properties over a sub-system exclusively consisting of mineral wool plates; the pull-through resistance is in particular improved and the insulation plate 2 provides a mechanical protection to the aerogel containing plate 3 due to its resilient characteristics.

The insulation shown in FIG. 7 consists of two plates 2, 3 each having a rectangular major surface of substantially the same length and width as the other plate 2, 3 and where the two plates 2, 3 are being placed commensurate so that the two plates 2, 3 substantially exactly cover each other. The insulation plate 2 is in this example a mineral wool laminar plate of the stone wool type where the mineral fibre direction is predominantly parallel to the major surface. The thickness of the insulation plate 2 is 40 mm and the width by length is 625 by 800 mm and the density of the insulation plate is 120 kg/m³. The aerogel containing plate 3 is in this example an aerogel matrix composite comprising polymer fibres in an aerogel matrix.

FIG. 8 shows an insulation sub-system 1 like in FIG. 7 with the amendment that the insulation plate 2 shown in FIG. 7 is a dual density insulation plate 2 of the stone wool type shown in FIG. 6, too, which has a surface layer 10 of about 20 mm thickness of a compacted mineral wool layer with a density of about 160 kg/m³ and a layer 11 of about 60 mm thickness of mineral wool layer with a density of about 90 kg/m³; the layer 11 with the lower density is facing outwards.

FIG. 9 shows an insulation sub-system 1 comprising an insulation plate 2 of mineral wool at the building wall 5 and arranging an aerogel containing plate 3 on top of the insulation plate 2 and arranging a further insulation plate 2 on top of the aerogel containing plate 3; the three plates 2, 3 are mounted with a mechanical fastener 4 into the wall 5 holding the plates 2, 3. Additionally the insulation plate 2 can be connected to the wall 5 by an adhesive and further adhesives can be present between the insulation plates 2 and the plate 3. Such adhesive can be the binder used in the insulation plate 2. The part of the ETICS is shown in cross section displaying the mechanical fastener 4. The mechanical fastener 4 is a polyamide based hollow dowel 7 with a metal screw 6 inserted in the hollow dowel 7 and the dowel 7 has a head 8 in shape of a round plate with a diameter of preferably around 60 mm.

The head 8 exerts a pressure on the surface of the insulation plate 2 and there is an indentation 9 into the surface due to the static hold force of the mounted screw and the mineral wool of insulation plate 2 is compressed between the fastener head 8 and the surface of the plate 3.

The total system of fasteners 4, the sandwich of the aerogel and mineral fibres containing plate 3 and the two outside layered insulation plates 2 is mechanically rigid and has improved properties over a sub-system exclusively consisting of mineral wool plates; the pull-through resistance is in particular improved but also the overall weight is lowered.

The insulation shown in FIG. 9 consists of three plates 2, 3 all having a rectangular major surface of substantially the same length and width as the other plates 2, 3 and where the three plates 2, 3 are being placed commensurate so that the three plates substantially exactly cover each other. The insulation plates 2 are in this example mineral wool laminar plates of the stone wool type where the mineral fibre direction is predominantly parallel to the major surfaces. The thickness is 80 mm and the width by length is 625 by 800 mm and the density of the mineral wool plate 2 is 100 kg/m³. The plate 3 is in this example an aerogel particle fibre composite comprising aerogel particles and a means for binding the constituents.

FIG. 10 shows an insulation sub-system 1 comprising an insulating composite plate 12 containing mineral wool and aerogel; the plate is mounted with a mechanical fastener 4 into the wall 5 holding the composite plate 12. The part of the ETICS is shown in cross section displaying the mechanical fastener 4. The mechanical fastener 4 is a polyamide based hollow dowel 7 with a metal screw 6 inserted in the hollow dowel 7 and the dowel 7 has a head 8 in shape of a round plate with a diameter of preferably around 60 mm.

The head 8 exerts a pressure on the surface of the composite plate 12 and there is an indentation 9 into the surface due to the static hold force of the mounted screw 6 and the composite plate 12 is compressed between the fastener head 8 and the surface of the composite plate 12.

The total system of fasteners 4, mineral wool-aerogel-composite plate 12 is mechanically rigid and has improved properties over a sub-system exclusively consisting of mineral wool; the pull-through resistance is in particular improved but also the overall weight is lowered.

The insulation shown in FIG. 10 has a rectangular major surface. The thickness is 120 mm and the width by length is 625 by 800 mm and the density of the composite plate 12 is 100 kg/m³.

According to the invention, the binder used in the insulation element 2, 3, 12 and/or for the connection of the insulation elements 2, 3, 12 to each other comprises a first component in form of one or more lignosulfonate lignins, e.g. following Example 54 as described above.

The diagram according to FIG. 2 shows absolute values of the delamination strength of an insulation element according to the invention (graph C₂) compared with the delamination strength of an insulation element containing one of the assignees prior art non-added formaldehyde binder shown in graph B₂ (following Comp. Ex. B) and the delamination strength of an insulation element containing traditional phenol-urea-formaldehyde binder shown in graph A2 (following Comp. Ex. A).

The delamination strength is measured according to EN 1607:2013 and the first initial measurement is carried out on unaged samples immediately or shortly after production of the insulation element. This initial testing and the respective average result of a representative number of samples is illustrated at time ‘0’ on the x-axis of the diagram. Said time ‘0’ corresponds with day ‘0’ respectively the start of the accelerated ageing test according to the following description below.

In order to determine the ageing resistance of mineral fibre products exposed to moisture and heating during the service life of constructions, such mineral fibre products with focus on mechanical properties are subjected to accelerated ageing. The ageing resistance is defined as the ability of the product to maintain the original mechanical properties, and it is calculated as the aged strength in percent of the original strength. The test procedure follows the so called Nordtest method NT Build 434:1995.05, extended to 28 days. The aim of said method is to expose insulation materials to accelerated ageing due to increased temperature and heat. It is applicable to all insulation materials manufactured as insulation boards. The method is not predictive i.e. it is not intended for assessment of the service life, but it is a precondition for a satisfactory performance that ageing due to this method does not cause major changes in the properties of the materials under investigation. Experiences over more than two decades with the Nordtest method have proven to deliver reliable data to ensure satisfactory mechanical performance of inter alia mineral fibre products as insulation elements for use in façade systems.

According to the method, a representative number of test specimens are exposed to heat-moisture action for 7, 14 and 28 days at 70±2° C. and 95±5% relative humidity (RH) in a climatic chamber. Subsequently, the specimens are placed at 23±2° C. and 50±5% RH for at least 24 hours and upon drying are prepared for testing of mechanical performance, like e.g. the delamination strength is measured according to EN 1607:2013, or compression strength according to EN 826:2013 as will be described further below.

The relative ageing resistance is then calculated in % of and based on the initial absolute value measured at time ‘0’.

Results are documented and illustrated for 7, 14 and 28 days of accelerated ageing.

With respect to the FIGS. 2 to 5 and examples given here, the insulation element is a bonded mineral fibre facade product, commercially available at the assignee or affiliated companies which has been produced with the different binder types mentioned and tested for its mechanical properties. The product in question provides a target density of around 145 kg/m³ and a loss on ignition (LOI) of approx. 3.5 wt.-%.

The following Table I shows the delamination strength [kPa] EN 1607 according to FIG. 2.

TABLE I

| | 0 days | 7 days | 14 days | 28 days |
|---|---|---|---|---|
| A₂ | 25.5 | 17.1 | 16.5 | 15.8 |
| B₂ | 27.1 | 14.7 | 14.9 | 12.4 |
| C₂ | 16.8 | 11.9 | 11.2 | 9.7 |

Table I shows the absolute delamination strength of the insulation element according to the invention (C₂) compared to an insulation element containing a phenol-formaldehyde binder (A₂) and to an insulation element containing a non-added formaldehyde binder (B₂) initially and after accelerated ageing. The corresponding graphs are shown in FIG. 2.

The following Table II shows the relative delamination strength according to table I in % of initial according to FIG. 3.

TABLE II

| | 0 days | 7 days | 14 days | 28 days |
|---|---|---|---|---|
| A₃ | 100.0 | 67.1 | 64.7 | 62.0 |
| B₃ | 100.0 | 54.2 | 55.0 | 45.8 |
| C₃ | 100.0 | 70.8 | 66.7 | 57.7 |

Table II shows the relative delamination strength of the insulation element according to the invention (C₃) compared to an insulation element containing a phenol-formaldehyde binder (A₃) and to an insulation element containing a non-added formaldehyde binder (B₃). The corresponding graphs are shown in FIG. 3.

In Table I and especially in Table II it can be seen that the delamination strength of the insulation element 4 according to the invention (C₂; C₃) does not differ that much from the delamination strength of the insulation element (A₂; A₃) containing a phenol-formaldehyde binder. Furthermore, it can be seen that the loss of delamination strength of the insulation element containing a non-added formaldehyde binder (B₂; B₃) increases much more than the delamination strength of the insulation element 4 according to the invention (C₂; C₃).

From Table II and FIG. 3 the relative delamination strength of the insulation element 4 according to the invention (C₃) compared to insulation elements containing a phenol-formaldehyde binder (A₃) or insulation elements containing a non-added formaldehyde binder (B₃) can be seen. All insulation elements 4 to be compared were exposed to an ageing process according to the before mentioned description.

In particular, it can be seen from Table II and from FIG. 3, that the relative values of the delamination strength of the insulation element 4 according to the invention (C₃) develop approximately equal and initially even remain slightly higher than the values of the delamination strength of the insulation element containing phenol-formaldehyde binder (A₃).

The following Table III shows the absolute compression strength [kPa] EN 826 according to FIG. 4.

TABLE III

| | 0 days | 7 days | 14 days | 28 days |
|---|---|---|---|---|
| A₄ | 76.8 | 60.5 | 61.6 | 56.5 |
| B₄ | 80.6 | 64.0 | 55.6 | 52.6 |
| C₄ | 67.4 | 53.1 | 49.9 | 49.5 |

Table III shows the absolute compression strength of the insulation element according to the invention (C₄) compared to an insulation element containing a phenol-formaldehyde binder (A₄) and to an insulation element containing a non-added formaldehyde binder (B₄). The corresponding graphs are shown in FIG. 4.

FIG. 4 shows the compression strength of an insulation element according to the invention (graph C₄) compared with the compression strength of an insulation element containing mineral fibres and a non-added formaldehyde binder shown in graph B₄ and the compression strength of an insulation element containing mineral fibres and a phenol-formaldehyde binder shown in graph A₄.

The compression strength is measured according to EN 826 and it can be seen, that the compression strength is measured immediately after production of the insulation element 4, and seven, fourteen and twenty-eight days after production of the insulation element 4 including accelerated ageing.

The following Table IV shows the relative compression strength according to table III in % of initial according to FIG. 5.

TABLE IV

| | 0 days | 7 days | 14 days | 28 days |
|---|---|---|---|---|
| A₅ | 100.0 | 78.8 | 80.2 | 73.6 |
| B₅ | 100.0 | 79.4 | 69.0 | 65.3 |
| C₅ | 100.0 | 78.8 | 74.0 | 73.4 |

Table IV shows the relative compression strength of the insulation element according to the invention (C₅) compared to an insulation element containing a phenol-formaldehyde binder (A₅) and to an insulation element containing a non-added formaldehyde binder (B₅). The corresponding graphs are shown in FIG. 5.

From FIG. 5 the relative compression strength of the insulation element 4 according to the invention (C₅) compared to insulation elements containing a phenol-formaldehyde binder (A₅) or insulation elements containing a non-added formaldehyde binder (B₅) can be derived. All insulation elements to be compared were exposed to an ageing process containing the steps as described before.

Furthermore, it can be seen from FIG. 5, that the relative development of the compression strength of the insulation element 4 according to the invention (C₅) compared with those of the compression strength of the insulation element containing phenol-formaldehyde binder (A₅) are somewhat similar and in particular the remaining strength after twenty-eight days being significantly than those for the insulation elements containing a non-added formaldehyde binder (B₅).

Hence, measurements have proven the binder and respective insulation elements produced with the binder according to the invention to provide a high ageing resistance comparably good as for state of the art phenol-formaldehyde binder.

1. A façade system for a building, in particular an External Thermal Insulation Composite System (ETICS), comprising a thermal and/or acoustic insulation, consisting of at least one insulation element being a bonded mineral fibre product made of mineral fibres, preferably stone wool fibres, and a cured aqueous binder composition free of phenol and formaldehyde, wherein the insulation element is fixed to an outer surface of the building by mechanical fastening elements and/or an adhesive, covered with a rendering, and whereby the aqueous binder composition prior to curing comprises
a component (i) in form of one or more lignosulfonate lignins having a carboxylic acid group content of 0.03 to 2.0 mmol/g, based on the dry weight of the lignosulfonate lignins and
a component (ii) in form of one or more cross-linkers,
and wherein the insulation element has a bulk density between 70 kg/m³ and 150 kg/m³.

2. A façade system according to claim 1, wherein the aqueous binder composition additionally comprises a component (iii) in form of one or more plasticizers.

3. A façade system according to claim 1, wherein the insulation element has a loss on ignition (LOI) within the range of 2 to 8 wt.-%, preferably 2 to 5 wt.-%.

4. A façade system according to any of the preceding claims, having insulation elements with a compression strength between 5 and 90 kPa measured in accordance with European Standard EN 826:2013.

5. A façade system according to any of the preceding claims, having insulation elements with a delamination strength between 5 and 100 kPa measured in accordance with European Standard EN 1607:2013

6. A façade system according to any of the preceding claims, wherein component (i) is having a carboxylic acid group content of 0.05 to 0.6 mmol/g, based on the dry weight of lignosulfonate lignins.

7. A façade system according to any of the preceding claims, wherein component (i) is in form of one or more lignosulfonate lignins having an average carboxylic acid group content of less than 1.8 groups per macromolecule considering the M_n wt. average of component (i), such as less than 1.4 such as less than 1.1 such as less than 0.7 such as less than 0.4.

8. A façade system according to any of the preceding claims, wherein component (i) is having a content of phenolic OH groups of 0.3 to 2.5 mmol/g, such as 0.5 to 2.0 mmol/g, such as 0.5 to 1.5 mmol/g, based on the dry weight of lignosulfonate lignins.

9. A façade system according to any of the preceding claims, wherein component (i) is having a content of aliphatic OH groups of 1.0 to 8.0 mmol/g, such as 1.5 to 6.0 mmol/g, such as 2.0 to 5.0 mmol/g, based on the dry weight of lignosulfonate lignins.

10. A façade system according to any of the preceding claims, wherein the component (i) comprises ammoniumlignosulfonates and/or calciumlignosulfonates, and/or magnesiumlignosulfonates, and any combinations thereof.

11. A façade system according to any of the preceding claims, wherein component (i) comprises ammoniumlignosulfonates and calciumlignosulfonates, wherein the molar ratio of NH₄⁺ to Ca²⁺ is in the range of 5:1 to 1:5, in particular 3:1 to 1:3.

12. A façade system according to any of the preceding claims, wherein the aqueous binder composition contains added sugar in an amount of 0 to less than 5 wt.-%, based on the weight of lignosulfonate and sugar.

13. A façade system according to any of the preceding claims, wherein the aqueous binder composition comprises component (i) in an amount of 50 to 98 wt.-%, such as 65 to 98 wt.-%, such as 80 to 98 wt.-%, based on the dry weight of components (i) and (ii).

14. A façade system according to any of the preceding claims, wherein the component (ii) is in form of one or more cross-linkers selected from
β-hydroxyalkylamide-cross-linkers, and/or
oxazoline-cross-linkers, and/or
the group consisting of multifunctional organic amines such as an alkanolamine, diamines, such as hexamethyldiamine, and/or
epoxy compounds having a molecular weight of more than 500, such as an epoxidised oil based on fatty acid triglyceride or one or more flexible oligomer or polymer, such as a low Tg acrylic based polymer, such as a low Tg vinyl based polymer, such as low Tg polyether, which contains reactive functional groups such as carbodiimide groups, such as anhydride groups, such as oxazoline groups, such as amino groups, such as epoxy groups, and/or
one or more cross-linkers selected from the group consisting of fatty amines; and/or
one more cross-linkers in form of fatty amides; and/or
one or more cross-linkers selected from polyester polyols, such as polycaprolactone; and/or
one or more cross-linkers selected from the group consisting of starch, modified starch, CMC; and/or
one or more cross-linkers in form of multifunctional carbodiimides, such as aliphatic multifunctional carbodiimides; and/or
one or more cross-linkers selected from melamine based cross-linkers, such as a hexakis(methylmethoxy)melamine (HMMM) based cross-linkers.

15. A façade system according to any of the preceding claims, wherein the component (ii) comprises one or more cross-linkers selected from β-hydroxyalkylamide-cross-linkers and/or oxazoline-cross-linkers.

16. A façade system according to any of the preceding claims, comprising component (ii) in an amount of 1 to 50 wt.-%, such as 4 to 20 wt.-%, such as 6 to 12 wt.-%, based on the dry weight of component (i).

17. A façade system according to any of the preceding claims, wherein the component (ii) is in form of one or more cross-linkers selected from
β-hydroxyalkylamide-cross-linkers, such as N-(2-hydroxyisopropyl)amide-cross-linkers, such as N-(2-hydroxyethyl)amide-cross-linkers, such as N-(2-hydroxyethyl)adipamide-cross-linkers, such as N,N,N′,N′-tetrakis(2-hydroxyethyl)adipamide and/or
the group consisting of multifunctional organic amines such as an alkanolamine, diamines, such as hexamethyldiamine, and/or
epoxy compounds having a molecular weight of more than 500, such as an epoxidised oil based on fatty acid triglyceride or one or more flexible oligomer or polymer, such as a low Tg acrylic based polymer, such as a low Tg vinyl based polymer, such as low Tg polyether, which contains reactive functional groups such as carbodiimide groups, such as anhydride groups, such as oxazoline groups, such as amino groups, such as epoxy groups, and/or
one or more cross-linkers in form of multifunctional carbodiimides, such as aliphatic multifunctional carbodiimides.

18. A façade system according to any of the preceding claims, wherein the component (ii) comprises one or more cross-linkers selected from
β-hydroxyalkylamide-cross-linkers, such as N-(2-hydroxyisopropyl)amide-cross-linkers, such as N-(2-hydroxyethyl)amide-cross-linkers, such as N-(2-hydroxyethyl) adipamide-cross-linkers, such as N,N,N′,N′-tetrakis(2-hydroxyethyl)adipamide.

19. A façade system according to any of the preceding claims, comprising component (ii) in an amount of 2 to 90 wt.-%, such as 6 to 60 wt.-%, such as 10 to 40 wt.-%, such as 25 to 40 wt.-%, based on the dry weight of component (i).

20. A façade system according to any of the preceding claims, wherein component (iii) is in form of
one or more plasticizers selected from the group consisting of fatty alcohols, monohydroxy alcohols, such as pentanol, stearyl alcohol; and/or
one or more plasticizers selected from the group consisting of alkoxylates such as ethoxylates, such as butanol ethoxylates, such as butoxytriglycol; and/or
one or more plasticizers in form of propylene glycols; and/or
one or more plasticizers in form of glycol esters; and/or
one or more plasticizers selected from the group consisting of adipates, acetates, benzoates, cyclobenzoates, citrates, stearates, sorbates, sebacates, azelates, butyrates, valerates; and/or
one or more plasticizers selected from the group consisting of phenol derivatives, such as alkyl or aryl substituted phenols; and/or
one or more plasticizers selected from the group consisting of silanols, siloxanes; and/or
one or more plasticizers selected from the group consisting of sulfates such as alkyl sulfates, sulfonates such as alkyl aryl sulfonates such as alkyl sulfonates, phosphates such as tripolyphosphates; and/or
one or more plasticizers in form of hydroxy acids; and/or
one or more plasticizers selected from the group consisting of monomeric amides, such as acetamides, benzamide, fatty acid amides such as tall oil amides; and/or
one or more plasticizers selected from the group consisting of quaternary ammonium such compounds as trimethylglycine, distearyldimethylammoniumchloride; and/or
one or more plasticizers selected from the group consisting of vegetable oils such as castor oil, palm oil, linseed oil, soybean oil; and/or
tall oil, and/or
one or more plasticizers selected from the group consisting of hydrogenated oils, acetylated oils; and/or
one or more plasticizers selected from acid methyl esters; and/or
one or more plasticizers selected from the group consisting of alkyl polyglucosides, gluconamides, aminoglucoseamides, sucrose esters, sorbitan esters; and/or
one or more plasticizers selected from the group consisting of polyethylene glycols, polyethylene glycol ethers; and/or
one or more plasticizers in form of polyols, such as glycerol, such as 1,1,1-Tris(hydroxymethyl)propane; and/or
triethanolamine.

21. A façade system according to any of the preceding claims, wherein component (iii) is in form of propylene glycols, phenol derivatives, silanols, siloxanes, hydroxy acids, vegetable oils, polyethylene glycols, polyethylene glycol ethers, triethanolamine, or any mixtures thereof.

22. A façade system according to any of the preceding claims, wherein component (iii) comprises one or more plasticizers having a boiling point of 100 to 380° C., more preferred 120 to 300° C., more preferred 140 to 250° C.

23. A façade system according to any of the preceding claims, wherein component (iii) comprises one or more polyethylene glycols having an average molecular weight of 150 to 50000 g/mol, in particular 150 to 4000 g/mol, more particular 150 to 1000 g/mol, preferably 150 to 500 g/mol, more preferably 200 to 400 g/mol.

24. A façade system according to any of the preceding claims, wherein the component (iii) is present in an amount of 0.5 to 60, preferably 2.5 to 25, more preferably 3 to 15 wt.-%, based on the dry weight of component (i).

25. A façade system according to any of the preceding claims, wherein the binder composition prior to curing comprises a further component (iv) in form of one or more coupling agents, such as organofunctional silanes.

26. A façade system according to any of the preceding claims, wherein in the binder composition prior to curing further comprises a component (v) in form of one or more components selected from the group of bases, such as ammonia, such as alkali metal hydroxides, such as KOH, such as earth alkaline metal hydroxides, such as Ca(OH)₂, such as Mg(OH)₂, such as amines or any salts thereof.

27. A façade system according to any of the preceding claims, wherein the binder composition prior to curing comprises a further component in form of urea, in particular in an amount 5 to 40 wt.-%, such as 10 to 30 wt.-%, such as 15 to 25 wt.-%, based on the dry weight of component (i).

28. A façade system according to any of the preceding claims, wherein the binder composition prior to curing comprises a further component (vi) in the form of one or more reactive or nonreactive silicones.

29. A façade system according to any of the preceding claims, wherein the insulation element does not contain an ammonia-oxidized lignin (AOL).

30. An insulation element for a façade system according to any of the preceding claims 1 to 29, made of mineral fibres, preferably stone wool fibres, and a cured aqueous binder composition free of phenol and formaldehyde, wherein the aqueous binder composition prior to curing comprises a component (i) in form of one or more lignosulfonate lignins having a carboxylic acid group content of 0.03 to 2.0 mmol/g, based on the dry weight of the lignosulfonate lignins, a component (ii) in form of one or more cross-linkers and wherein the insulation element has a bulk density between 70 kg/m³ and 150 kg/m³.

31. An insulation element according to claim 30, wherein the aqueous binder composition additionally comprises a component (iii) in form of one or more plasticizers.

32. An insulation element according to claim 30 or 32, further comprising the features of the insulation element of any of claims 2 to 29.
